(19) United States
(12) Patent Application Publication
(10) Pub. No.: US 2025/0359642 A1
(43) Pub. Date: Nov. 27, 2025

(54) WIRELESS CHARGING CASE

(71) Applicant: Valve Corporation, Bellevue, WA (US)

(72) Inventors: Joshua Mark Hudman, Issaquah, WA (US); Charles N. Lohr, Bellevue, WA (US); Aaron Leiby, Seattle, WA (US)

(21) Appl. No.: 18/673,058

(22) Filed: May 23, 2024

(51) Int. Cl. A45C 15/00; A45C 11/00; A45C 13/02; G06F 1/16; H02J 7/00; H02J 50/10; H02J 50/40

(52) U.S. Cl. CPC A45C 15/00; A45C 11/00; A45C 13/02; G06F 1/163; H02J 7/0013; H02J 7/0044; H02J 7/0048; H02J 7/00712; H02J 50/10; H02J 50/40; A45C 11/003; A45C 2013/025

(57) ABSTRACT

A case for an electronic device(s) is described, the case being configured to automatically, and wirelessly, charge a battery(ies) of the electronic device(s). The electronic device(s) may be a head-mounted display (HMD) and/or a handheld controller(s), and the case may include a recessed area(s) inside of the case, the recessed area(s) being shaped to receive the electronic device(s). The case may further include a connector(s) configured to access a power source(s), and a wireless power transmitter(s) configured to wirelessly transmit power received from the power source to a wireless power receiver(s) of the electronic device(s) in response to the electronic device(s) being placed in the recessed area(s) to charge the battery(ies) of the electronic device(s).

### BACKGROUND

Head-mounted displays (HMDs) and handheld controllers are used in various fields including engineering, medical, military, and video gaming. HMDs present graphical information or images to a user as part of a virtual reality (VR), augmented reality (AR), and/or a mixed reality (MR) environment. As an example, while playing a VR video game, a user may wear a HMD to be immersed within a virtual environment. Handheld controllers are used for providing input, for example, to a local or remote computing device. In the example above, the user may operate a pair of handheld controllers to interact with the VR video game while wearing the HMD to view the video game content.

HMDs and handheld controllers can be implemented as portable, battery-powered electronic devices to provide the user with greater mobility, as compared to a tethered HMD and/or wired controllers, for example. One drawback of battery-powered electronic devices is that they eventually run out of charge. For example, after a session of using a battery-powered electronic device, a user may set down the electronic device until they want to use it again. If the user forgets to plug in the electronic device to recharge its battery, the user may discover that the electronic device is out of charge when the user would like to start another session with the device. In this scenario, the electronic device is rendered useless, and the user must plug in the device and wait for its battery to reach a threshold charge level before starting the next session.

Provided herein are technical solutions to improve and enhance these and other systems.

### BRIEF DESCRIPTION OF THE DRAWINGS

The detailed description is described with reference to the accompanying drawings. In the figures, the left-most digit(s) of a reference number identifies the figure in which the reference number first appears. The use of the same reference numbers in different figures indicates similar or identical components or features.

FIG. 1 illustrates an example system including a case for a HMD, a first handheld controller, and a second handheld controller, the case being configured to wirelessly charge the batteries of the HMD and the controllers while the HMD and the controllers are in the case, in accordance with embodiments disclosed herein.

FIG. 2 illustrates an example system including a case for a handheld controller, the case being configured to wirelessly charge the battery of the controller while the controller is in the case, in accordance with embodiments disclosed herein.

FIG. 3 illustrates circuit board of a case for an electronic device(s), the circuit board having, among other things, an induction coil(s) for transmitting power wirelessly to a wireless power receiver(s) of the electronic device(s), in accordance with embodiments disclosed herein.

FIG. 4 illustrates a flow diagram of an example process for charging a battery(ies) of an electronic device(s) via wireless power transmission from a case for the electronic device(s), in accordance with embodiments disclosed herein.

FIG. 5 illustrates a flow diagram of an example process for charging a battery(ies) of a case for an electronic device(s), in accordance with embodiments disclosed herein.

FIG. 6 illustrates example components of a case for an electronic device(s), in accordance with embodiments disclosed herein.

FIG. 7 illustrates example components of an electronic device(s) that is configured to be stored in a case, in accordance with embodiments disclosed herein.

### DETAILED DESCRIPTION

Described herein is, among other things, a case for an electronic device(s), the case being configured to automatically, and wirelessly, charge a battery(ies) of the electronic device(s). As noted above, batteries of electronic devices, such as HMDs, handheld controllers, and the like, eventually run out of charge. As described herein, a case for an electronic device(s), such as a HMD and/or a handheld controller, may include a connector(s) configured to access a power source, and a wireless power transmitter(s) configured to wirelessly transmit power received from the power source to a wireless power receiver(s) of the electronic device(s). The power source can be mains electricity (or grid power), and the connector, in some examples, is a power cable port disposed on an external surface of the case. In these examples, a user can plug one end of a power cable into the power cable port of the case, and the other end of the power cable into an electrical outlet (e.g., a wall outlet), and the wireless power transmitter(s) of the case may receive power from mains electricity (e.g., via the power cable port) and transmit the power wirelessly to the wireless power receiver(s) of the electronic device(s) to charge a battery(ies) of the electronic device(s). In some examples, a battery(ies) disposed within a battery receptacle(s) of the case can serve as a power source for wireless charging. In these examples, the connector can be a battery connector disposed within the battery receptacle, and the wireless power transmitter(s) of the case may receive power from the battery(ies) of the case (e.g., via the battery connector) and transmit the power wirelessly to the wireless power receiver(s) of the electronic device(s) to charge the battery(ies) of the electronic device(s). In this manner, the battery(ies) of the electronic device(s) can charge, or recharge, even in the absence of mains electricity. For example, a user may stow the electronic device(s) in the case and carry the case with them as they travel from one geographic location (e.g., the user's home) to another geographic location (e.g., the user's office, a public park, etc.). While the electronic device(s) is stowed in the case, the battery(ies) of the electronic device(s) can charge, or recharge, even while the case is being transported (e.g., on a bus, in a car, etc.).

The case may include one or more recessed areas inside of the case. The recessed area(s) can be shaped to receive the electronic device(s). For example, the case may include a recessed area that is shaped to receive a HMD. Additionally, or alternatively, the case may include a recessed area(s) that is/are shaped to receive a handheld controller(s). In the examples described herein, the wireless power transmitter(s) of the case is configured to wirelessly transmit power to a wireless power receiver(s) of the electronic device(s) in response to the electronic device(s) being placed in its designated recessed area(s) to charge a battery(ies) of the electronic device(s). Accordingly, a user can place an electronic device in its designated recessed area inside of the case, and the battery(ies) of the electronic device can automatically charge, or recharge, without the user having to plug any power cords into the electronic device. The case is a convenient place to store the electronic device(s) when the user is not using the electronic device(s). Accordingly, using the case to wirelessly charge the battery(ies) of an electronic device(s) is a natural, convenient way to ensure that the electronic device(s) is charging in between sessions, thereby ensuring that the electronic device(s) has enough charge the next time the user retrieves the electronic device(s) from the case in order to use the electronic device(s) in a subsequent session.

In some examples, the wireless power transmitter(s) of the case can be implemented as a relatively low-cost induction coil(s) integrated into a circuit board of the case, which is much cheaper to manufacture than discrete, heavy gauge, copper windings that are typically used as induction coils for high power applications and/or fast charging. Because a relatively low charging rate may be permissible, the cost savings to manufacture the case with the low-cost induction coil(s) as a wireless power transmitter(s) translates to a lower retail price for the case and/or a product bundle that includes the case.

In some examples, the wireless power transmitter(s) of the case is configured to charge the battery(ies) of an electronic device(s) even when the electronic device(s) is not perfectly seated in the recessed area(s) designated for the electronic device(s). In other words, the user does not have to make sure that the electronic device is seated perfectly in its designated recessed area inside of the case to ensure that the battery of the electronic device is charging. Instead, power may be transferred wirelessly from the case to the electronic device even if the electronic device is askew, misaligned, or otherwise imperfectly seated within its designated recessed area inside of the case. This can be enabled by controlling the wireless charging range/distance such that the electronic device may begin receiving power as soon as the electronic device is within a threshold distance of the wireless power transmitter(s) (e.g., induction coil(s)) of the case, such as within inches of wireless power transmitter(s), and even if the wireless power transmitter(s) of the case and the wireless power receiver(s) of the electronic device(s) are not aligned perfectly parallel to one another. In these examples, relatively slow charging rates may be permissible due to imperfect alignments, and/or greater distances, between the wireless power transmitter(s) and the wireless power receiver(s). This provides for an enhanced user experience where the user can set the electronic device(s) inside of the case (without having to fidget with the position and/or orientation of the electronic device(s) within the case), and the electronic device will start charging from power transmitted wirelessly from the case.

An example case includes a recessed area(s) inside of the case, a connector(s), and a wireless power transmitter(s). The recessed area(s) is shaped to receive the electronic device(s), and the connector(s) is configured to access a power source(s). The wireless power transmitter(s) is configured to wirelessly transmit power received from the power source(s) to a wireless power receiver(s) of the electronic device(s) in response to the electronic device(s) being placed in the recessed area(s) to charge a battery(ies) of the electronic device(s). In some examples, the electronic device(s) is a HMD and/or a handheld controller.

An example process for charging a battery(ies) of an electronic device(s) includes detecting, by a processor(s) of a case for the electronic device(s), that the electronic device(s) has been placed in a recessed area(s) inside of the case. In response to the detecting, the processor(s) may cause a wireless power transmitter(s) of the case to wirelessly transmit power received from a power source(s) to a wireless power receiver(s) of the electronic device(s) to charge the battery of the electronic device(s). In some examples, the electronic device(s) is a HMD and/or a handheld controller.

Also disclosed herein are devices, systems, and non-transitory computer-readable media storing computer-executable instructions to implement the techniques and processes disclosed herein. Although the techniques and systems disclosed herein are discussed, by way of example, in the context of devices and systems that can be used for playing video games, it is to be appreciated that the techniques and systems described herein may provide benefits with other devices and systems, including, without limitation, industrial systems, defense systems, robotics systems, and the like. That being said, in at least one example, the disclosed wireless charging case may be configured to store and transport gaming devices, such as those used in a VR gaming system (e.g., a HMD and a pair of handheld controllers), and/or a handheld controller with an integrated display used for mobile gaming.

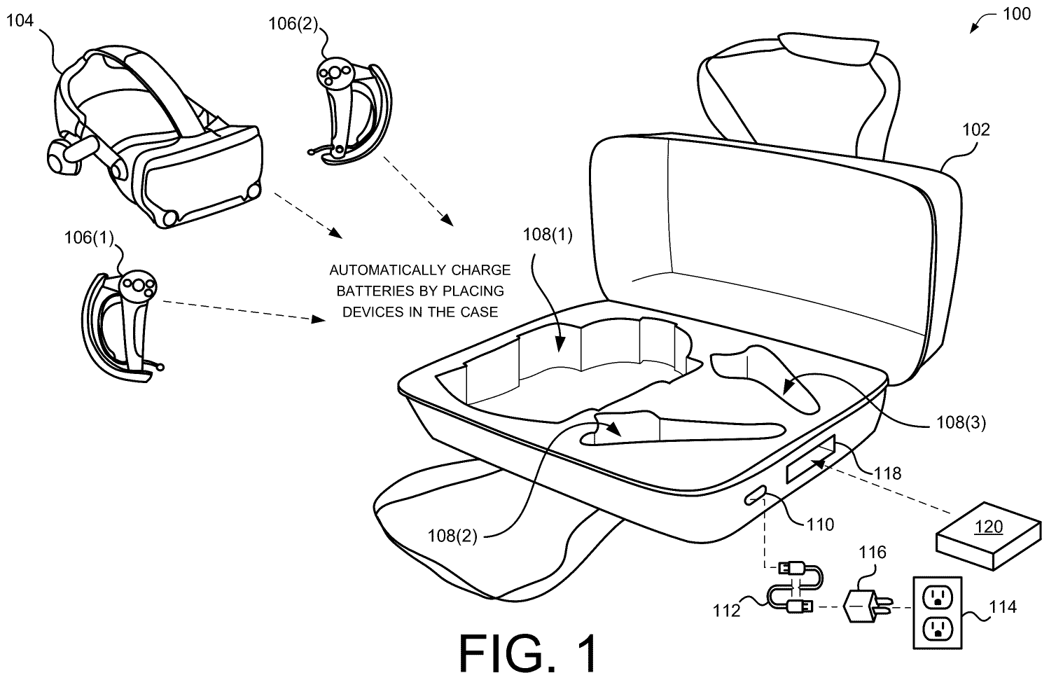

FIG. 1 illustrates an example system 100 including a case 102, a HMD 104, a first handheld controller 106(1), and a second handheld controller 106(2). The case 102 may be configured to store and transport the HMD 104 and the pair of handheld controllers 106(1) and 106(2) (collectively 106, and sometimes referred to herein as “controllers 106”). The case 102 is also configured to wirelessly charge the batteries of the HMD 104 and the controllers 106 while the HMD 104 and the controllers 106 are in the case 102. The HMD 104 and the controllers 106 are examples of battery-powered, electronic devices that can be stored in a case, such as the case 102. Accordingly, the HMD 104 and the controllers 106 may be referred to herein more generally as “electronic devices” or, simply as “devices.” It is to be appreciated that other types of battery-powered, electronic devices may be automatically, and wirelessly, charged while they are in a case, such as the case 102, and that the case 102 may be configured to store and/or transport other types and/or numbers of electronic devices. Examples of other types of electronic devices that may be placed in a case to charge their respective batteries include, without limitation, laptop computers, mobile phones, tablet computers, other wearable computers (e.g., smart watches, etc.), or any other electronic device that includes a rechargeable battery(ies).

The HMD 104 depicted in FIG. 1 is a device that is to be worn by a user (e.g., on a head of the user). In some examples, the HMD 104 may be head-mountable, such as by allowing a user to secure the HMD 104 on their head using a securing mechanism (e.g., an adjustable band(s), strap(s), etc.) that is sized to fit around a head of a user. In some examples, the HMD 104 comprises a VR, AR, and/or MR headset that includes a near-eye or near-to-eye display(s). As such, the terms “wearable device”, “wearable electronic device”, “VR headset”, “AR headset”, “MR headset,” and “head-mounted display (HMD)” may be used interchangeably herein to refer to the HMD 104. Examples described herein pertain primarily to a VR-based HMD 104 for use in VR systems, such as for use with a VR gaming system. However, the HMD 104 may additionally, or alternatively, be implemented as an AR headset for use in AR applications, a MR headset for use in MR applications, or a headset that is usable for VR, AR, and/or MR applications that are not game-related (e.g., industrial applications, robot applications, military/weapon applications, medical applications, or the like). It is also to be appreciated that the HMD 104 may be implemented in a variety of other form factors (e.g., glasses, a visor, etc.). In some examples, the HMD 104 is a standalone HMD 104 (sometimes referred to as an “all-in-one” HMD 104) that is operable without assistance, or with minimal assistance, from a separate computer(s). In these examples, the standalone HMD 104 may nevertheless be communicatively coupled with one or more handheld controllers 106, such as the first handheld controller 106(1) and the second handheld controller 106(2) depicted in FIG. 1.

An individual handheld controller(s) 106 may have various finger-operated and/or hand-operated controls for a user to provide user input. For example, the handheld controller(s) 106 may include a joystick(s), a trackpad(s), a trackball(s), a button(s), a directional pad(s) (D-pad(s)), a trigger(s), a bumper(s), a proximity sensor(s) (e.g., to detect finger position, finger movement, finger gestures, etc.), a pressure sensor(s) (e.g., to detect hard presses and/or squeezing of portions of the handheld controller(s) 106, such as the handle), a motion sensor(s), such as an accelerometer(s), gyroscope(s), or the like to detect movement (e.g., translational movement, rotational movement (e.g., tilting), etc.) of the handheld controller(s) 106 in space, and/or any other suitable type of control.

The HMD 104 and the handheld controller(s) 106 depicted in FIG. 1 collectively represent at least part of a system for executing an application (e.g., a video game) to render associated video content (e.g., a series of images) on a display panel(s) of the HMD 104, and/or to output sounds corresponding to audio content of the executing application via one or more speakers of the HMD 104. The HMD 104 and the handheld controller(s) 106 may be communicatively coupled together wirelessly and/or via a wired connection. For example, the HMD 104 and the controllers 106 may exchange data with each other, and/or with a separate host computer(s), using Wi-Fi, Bluetooth, radio frequency (RF), and/or any other suitable wireless protocol. Additionally, or alternatively, the HMD 104 and the controllers 106 may include one or more physical ports to facilitate a wired connection (e.g., a tether, a cable(s), etc.) for data transfer therebetween, and/or between the HMD 104, the controllers 106, and a host computer(s). By being communicatively coupled together, the HMD 104 and the handheld controller(s) 106 may be configured to work together in a collaborative fashion (potentially in conjunction with a host computer) to output video content and/or audio content via the HMD 104. Tracking transducers (e.g., optical sensors, optical beacons, etc.) may be disposed on the HMD 104 and the controllers 106 to allow for tracking position and orientation of the devices in three-dimensional (3D) space (e.g., a tracking volume).

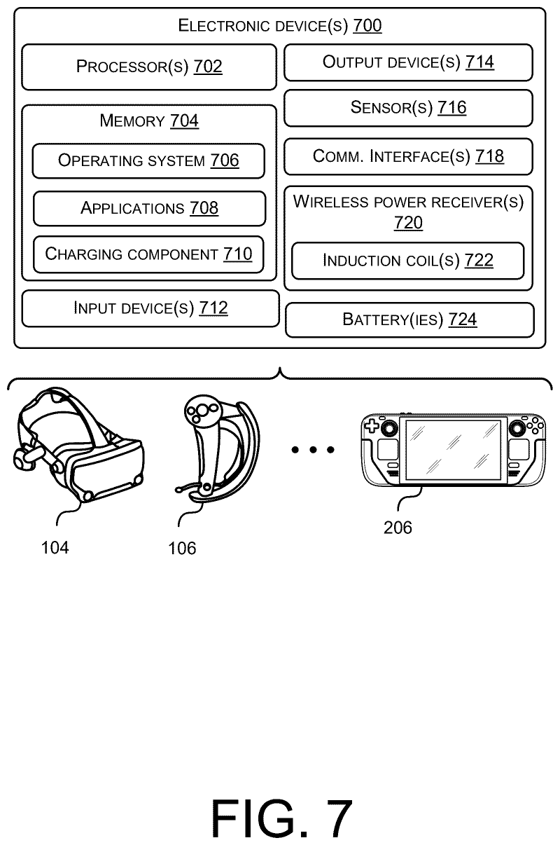

The HMD 104 may include one or more first batteries that are configured to power one or more electronic components of the HMD 104 during use of the HMD 104. Example components, including one or more batteries 724, of an electronic device 700 are shown in FIG. 7 and described in more detail below. The HMD 104 is one example of an electronic device 700 shown in FIG. 7. Similarly, the first handheld controller 106(1) may include one or more second batteries 724 that are configured to power one or more electronic components of the first handheld controller 106(1) during use of the first handheld controller 106(1), and the second handheld controller 106(2) may include one or more third batteries 724 that are configured to power one or more electronic components of the second handheld controller 106(2) during use of the second handheld controller 106(2). Each of the controllers 106 depicted in FIG. 1 is another example of an electronic device 700 shown in FIG. 7. Accordingly, any reference that is made herein to an electronic device(s) 700 may be interpreted as a HMD 104 and/or a handheld controller 106, in some examples. The HMD 104 and the controllers 106 depicted in FIG. 1 provide a user with mobility during use of the HMD 104 and the controllers 106. For example, the user can play a VR video game anywhere (e.g., in a public park) using the HMD 104 and the controllers 106, and/or the user can move about a play space without concern of inadvertently unplugging, or tripping over, cords. However, the batteries 724 of the HMD 104 and the controllers 106 eventually run out of charge after they are used for a period of time. In accordance with the examples described herein, a user may place the HMD 104 and the controllers 106 in the case 102 after a session of using the HMD 104 and the controllers 106, and the HMD 104 and the controllers 106 can remain in the case 102 until they are used again. While the HMD 104 and the controllers 106 are disposed in the case 102, the respective batteries 724 of the HMD 104 and the controllers 106 are recharged automatically and wirelessly. Accordingly, the next time a user removes the HMD 104 and the controllers 106 from the case 102 to start another session, the batteries 724 of the HMD 104 and the controllers 106 will have recharged. If the HMD 104 and the controllers 106 remain in the case 102 long enough to recharge to, or above, a threshold charge level, the batteries 724 of the HMD 104 and the controllers 106 will have enough charge to be utilized in another session.

The case 102 can have one or more recessed areas 108 inside of the case 102. For example, the recessed area(s) 108 can be defined in a base portion of the case 102 that is configured to rest upon a flat surface (e.g., a table, a floor, etc.). In the example of FIG. 1, the case 102 includes three recessed areas 108(1), 108(2), and 108(3) (collectively 108) inside of the case 102. The first recessed area 108(1) can be shaped to receive the HMD 104. For example, the first recessed area 108(1) may resemble an outline, or profile, of the HMD 104. The shape of the recessed area(s) 108 of the case 102 can serve various purposes. Firstly, the shape of the recessed area(s) 108 can serve as an identifier for the user to identify the designated area inside of the case 102 to stow the particular device 700. In the example of FIG. 1, by observing the shape of the first recessed area 108(1), a user may realize that the HMD 104 has a similar shape to the first recessed area 108(1), and the user can readily identify the first recessed area 108(1) as the location inside of the case 102 that is designated for the HMD 104. Secondly, the shape of the recessed area(s) 108 can mitigate damage inflicted upon the device 700 during transport. For example, the HMD 104 may fit snugly within the first recessed area 108(1) so that the HMD 104 does not get jostled around inside of the case 102 during transport, thereby mitigating damage to the HMD 104. Thirdly, the shape of the recessed area(s) 108 can serve as an alignment aid for wireless charging of the device's battery(ies) 724. For example, a wireless power transmitter(s) of the case 102 may be positioned directly underneath or beside a portion of the first recessed area 108(1) so that, when the HMD 104 is placed in the first recessed area 108(1), the HMD 104 is positioned and oriented such that the wireless power transmitter(s) is aligned with, and in close proximity to, a wireless power receiver(s) of the HMD 104. In some examples, the wireless power receiver(s) of the HMD 104 is located in the head strap of the HMD 104, such as at the back of the HMD 104 within the portion of the head strap that is near the back of the user's skull (e.g., near the occipital bone) when the HMD 104 is donned by the user, and/or at the side(s) or lateral portions of the head strap that is/are near the side(s) of the user's skull when the HMD 104 is donned by the user. The second recessed area 108(2) can be shaped to receive the first handheld controller 106(1), and the third recessed area 108(3) can be shaped to receive the second handheld controller 106(2), and the shapes of these recessed areas 108(2), 108(3) can serve similar purposes with respect to the handheld controllers 106. In an example, the second recessed area 108(2) may resemble an outline, or profile, of the first handheld controller 106(1), and the third recessed area 108(3) may resemble an outline, or profile, of the second handheld controller 106(2). Because the handheld controllers 106(1) and 106(2) depicted in FIG. 1 have similar shapes, outlines, and/or profiles, the second recessed area 108(2) and the third recessed area 108(3) may have similar shapes.

The case 102 may further include one or more connectors configured to access one or more power sources. In the example of FIG. 1, the case 102 includes a first connector in the form of a power cable port 110. The power cable port 110 is disposed on an external surface of the case 102 so that the power cable port 110 can be readily accessed by a user even when the case 102 is closed (e.g., zipped or snapped shut). The power cable port 110 is configured to receive a power cable 112. In this example, mains electricity (or grid power) may serve as a power source. In order to access this power source, a first end of the power cable 112 may be plugged into the power cable port 110, and a second end of the power cable 112 may be plugged into an electrical outlet 114 (e.g., a wall outlet), such as via an alternating current (AC) adapter 116. In some examples, the power cable 112 is a universal serial bus (USB) cable, such as a USB-C cable, and the power cable port 110 is a USB port, such as a USB-C port. In some examples, the power source may be a personal computer (PC), a laptop, a battery power bank, or any other suitable device and/or system that is external to the case 102 and configured to serve as a power source. In these examples, the second end of the power cable 112 may be plugged into a power cable port on the external power source (e.g., a power cable port disposed on the PC, laptop, battery power bank, etc.). It may be convenient for a user to leave the case 102 plugged into the power source while the case 102 is located at their home (or a similar location frequently visited by the user), and to leave the case 102 open on a table, a shelf, or the floor. In this manner, the case 102 can serve as a convenient storage location for the HMD 104 and the controllers 106 when they are not being used. Accordingly, whenever the user places the HMD 104 and the controllers 106 in the case 102, the HMD 104 and the controllers 106 can be automatically, and wirelessly, charged from power source.

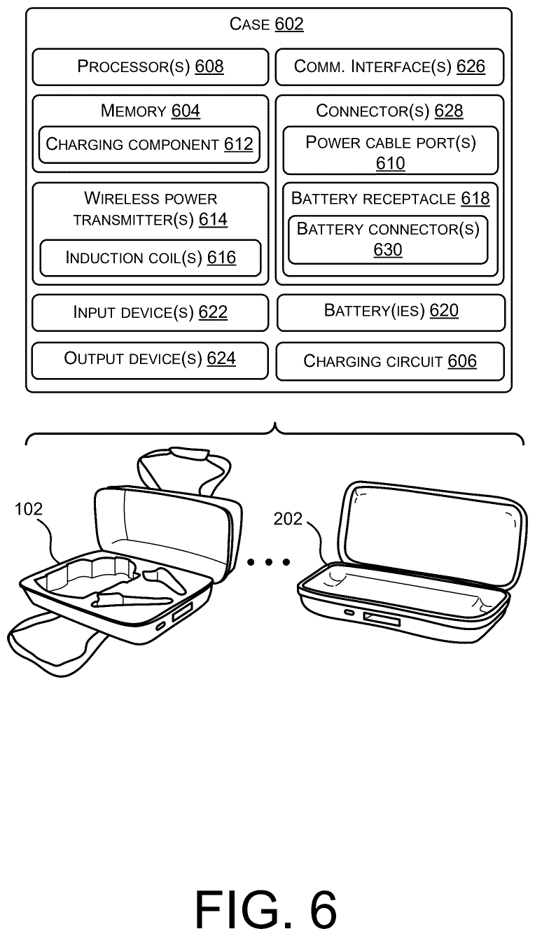

In some examples, it may be useful to charge the batteries 724 of the HMD 104 and the controllers 106 “on-the-go,” such as while a user is commuting to work (e.g., on a bus, in a car, etc.) and carrying the case 102 with the HMD 104 and the controllers 106 stowed in the case 102. Accordingly, in some examples, the case 102 may further include a battery receptacle 118 that is configured to receive a battery(ies) 120. In some examples, the case 102 may be purchased with the battery(ies) 120, while in other example, the battery(ies) 120 may not be included with the purchase of the case 102. It may be desirable for some users to purchase the case 102 without the battery(ies) 120 if, say, they do not want the battery(ies) 120 to add weight to the case 102. Such users may choose to refrain from purchasing a battery(ies) 120 for the case 102 to have a lighter-weight case 102. In some examples, the case 102 may omit the battery receptacle 118. In examples where the case 102 includes the battery receptacle 118, some users may decide to purchase the battery(ies) 120 separately and use the battery(ies) 120 for mobile charging of their HMD 104 and controllers 106, such as when access to mains electricity is unavailable. Accordingly, the battery(ies) 120 can be inserted into the battery receptacle 118 and utilized as yet another power source for wireless charging. In this example, the case 102 includes a second connector in the form of a battery connector(s) (See FIG. 6, which illustrates a battery connector(s) 630 of the case 602) disposed within the battery receptacle 118. When the battery(ies) 120 is disposed within the battery receptacle 118, the battery(ies) 120 is connected to the battery connector 630 to allow for accessing power from the battery(ies) 120.

In some examples, the battery receptacle 118 is configured to receive different types of batteries, such as batteries ranging from lightweight, low power storage capacity batteries to heavyweight, high power storage capacity batteries. In this manner, the user can decide the type of battery to purchase for their case 102, depending on the needs of the user. For example, a user who plans to use the case 102 predominantly and/or frequently for mobile charging (e.g., a user with a lengthy commute to work who likes to take their HMD 104 and controllers 106 to work) may decide to purchase a battery(ies) 120 with high power storage capacity. As another example, a different user may want the option of mobile charging, but may not plan on using mobile charging very often or for very long periods of time, and, hence, this user may choose a lightweight battery(ies) 120 that has a lower power storage capacity, which adds minimal extra weight to the case 102. Although the power cable port 110 and the battery receptacle 118 are shown as being disposed on a side the case 102 on a base portion of the case 102, it is to be appreciated that one or both of the power cable port 110 or the battery receptacle 118 can be disposed elsewhere on, or in, the case 102. For example, the battery receptacle 118 may be disposed inside of the case 102 or on a bottom of the base portion of the case 102.

The case 102 may further include one or more wireless power transmitters (See FIG. 6, which illustrates a wireless power transmitter(s) 614 of the case 602, which may represent the case 102). The wireless power transmitter(s) 614 is configured to wirelessly transmit power received from a power source(s) (e.g., mains electricity, the battery(ies) 120, etc.) to respective wireless power receivers of the HMD 104, the first handheld controller 106(1), and the second handheld controller 106(2). FIG. 7 illustrates a wireless power receiver(s) 720 of an electronic device 700 (e.g., the HMD 104 and/or the controllers 106). In some examples, the wireless power transmitter(s) 614 is configured to wirelessly transmit the power to a wireless power receiver 720 of an electronic device 700 (e.g., the HMD 104, the first handheld controller 106(1), the second handheld controller 106(2), etc.) in response to the electronic device 700 being placed in its designated recessed area 108 inside of the case 102. This wireless transmission of power allows for charging a battery(ies) 724 of the electronic device 700. For example, in response to the HMD 104 being placed in the first recessed area 108(1) inside of the case 102, a wireless power transmitter(s) 614 of the case 102 may wirelessly transmit power to a first wireless power receiver(s) 720 of the HMD 104 to automatically charge, or recharge, a first battery 724 of the HMD 104. Additionally, or alternatively, in response to the first handheld controller 106(1) being placed in the second recessed area 108(2) inside of the case 102, a wireless power transmitter(s) 614 of the case 102 may wirelessly transmit power to a second wireless power receiver(s) 720 of the first handheld controller 106(1) to automatically charge, or recharge, a second battery 724 of the first handheld controller 106(1). Additionally, or alternatively, in response to the second handheld controller 106(2) being placed in the third recessed area 108(3) inside of the case 102, a wireless power transmitter(s) 614 of the case 102 may wirelessly transmit power to a third wireless power receiver(s) 720 of the second handheld controller 106(2) to automatically charge, or recharge, a third battery 724 of the second handheld controller 106(2).

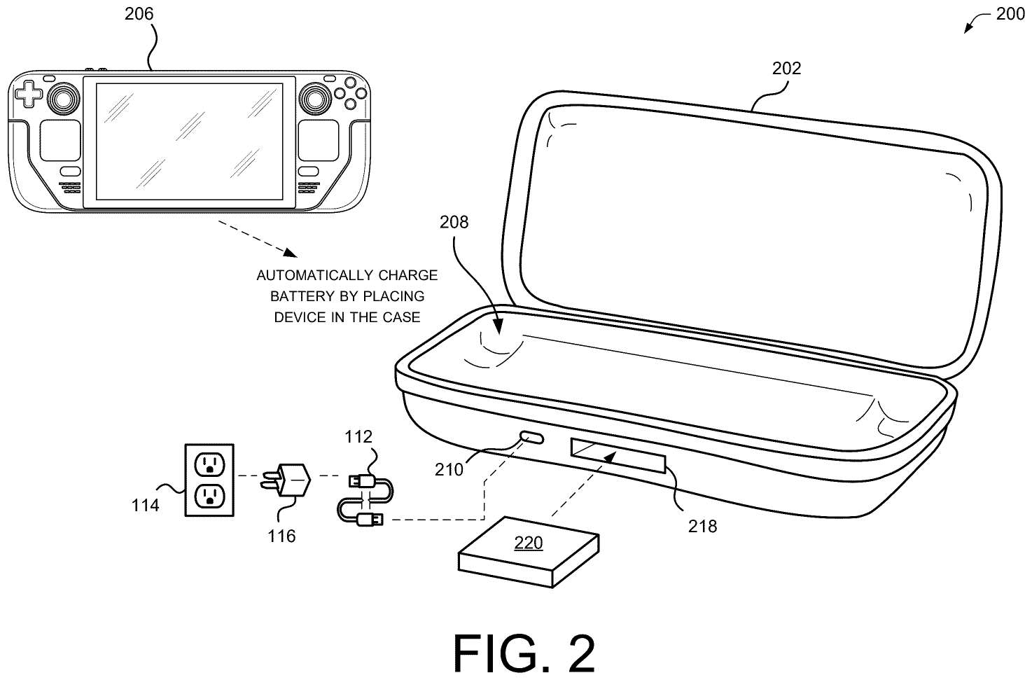

FIG. 2 illustrates an example system 200 including a case 202 and a handheld controller 206. The handheld controller(s) 206 (sometimes referred to herein as a “controller 206”) may have various finger-operated and/or hand-operated controls for a user to provide user input, and a display(s) for viewing content of an executing application (e.g., a video game). In this example, the handheld controller 206 may be used as a standalone, portable gaming device. The handheld controller(s) 206 may include a joystick(s), a trackpad(s), a trackball(s), a button(s), a D-pad(s), a trigger(s), a bumper(s), a proximity sensor(s) (e.g., to detect finger position, finger movement, finger gestures, etc.), a pressure sensor(s) (e.g., to detect hard presses and/or squeezing of portions of the handheld controller(s) 206, such as the handles), a motion sensor(s), such as an accelerometer(s), gyroscope(s), or the like to detect movement (e.g., translational movement, rotational movement (e.g., tilting), etc.) of the handheld controller(s) 206 in space, and/or any other suitable type of control. Accordingly, a user may operate one or more of the controls of the handheld controller 206 to play a video game while viewing content (e.g., images) of the video game on a centrally located display.

The handheld controller 206 is yet another example of an electronic device 700 shown in FIG. 7. Accordingly, any reference that is made herein to an electronic device(s) 700 may be interpreted as a handheld controller 206, in one example. As such, the handheld controller 206 may include a battery(ies) 724 to power one or more electronic components of the controller 206. The case 202 is configured to wirelessly charge the battery 724 of the handheld controller 206 while the controller 206 is in the case 202.

The case 202 can have one or more recessed areas 208 inside of the case 202, which may be similar to the recessed areas 108 described above with reference to FIG. 1. In an example, the recessed area 208 is defined in a base portion of the case 202 that is configured to rest upon a flat surface (e.g., a table, a floor, etc.). The recessed area 208 can be shaped to receive the handheld controller 206. For example, the recessed area 208 may resemble an outline, or profile, of the handheld controller 206.

The case 202 can further include one or more connectors configured to access one or more power sources. In the example of FIG. 2, the case 202 includes a first connector in the form of a power cable port 210, which may be the same as, or similar to, the power cable port 110 described above with respect to FIG. 1 (e.g., a USB-C port). In some examples, the case 202 may further include a battery receptacle 218 configured to receive a battery(ies) 220. The battery receptacle 218 may be the same as, or similar to, the battery receptacle 118 described above with respect to FIG. 1, and the battery(ies) 220 may be the same as, or similar to, the battery(ies) 120 described above with respect to FIG. 1. Accordingly, the case 202 may be configured for mobile charging, as well as charging from mains electricity (e.g., grid power), if available, and/or any other suitable power source (e.g., a PC, a laptop, a battery power bank, etc.).

The case 202 may further include one or more wireless power transmitters 614 that are configured to wirelessly transmit power received from a power source(s) (e.g., mains electricity, the battery(ies) 220, etc.) to a wireless power receiver(s) 720 of the handheld controller 206. In some examples, the wireless power transmitter(s) 614 of the case 202 is configured to wirelessly transmit the power to a wireless power receiver(s) 720 of the handheld controller 206 in response to the controller 206 being placed in its designated recessed area 208. This wireless transmission of power allows for charging a battery(ies) 724 of the handheld controller 206. For example, in response to the handheld controller 206 being placed in the recessed area 208, a wireless power transmitter(s) 614 of the case 202 may wirelessly transmit power to a wireless power receiver(s) 720 of the handheld controller 206 to automatically charge, or recharge, a battery(ies) 724 of the handheld controller 206.

The case 102 depicted in FIG. 1 is an example of a case 602 shown in FIG. 6, and the case 202 depicted in FIG. 2 is yet another example of the case 602 shown in FIG. 6. Accordingly, any reference that is made herein to a case 602 may be interpreted as a case 102 or a case 202, in some examples. It is to be appreciated that a single wireless power transmitter 614 of the case 602 may be configured to wirelessly transmit power to multiple wireless power receivers 720 of multiple electronic devices 700, such as the HMD 104, the first handheld controller 106(1), and the second handheld controller 106(2) depicted in FIG. 1. In some examples, the case 602 includes a wireless power transmitter(s) 614 dedicated for a specific electronic device(s) 700. For example, the case 102 depicted in FIG. 1 may have multiple (e.g., three) wireless power transmitters 614, one wireless power transmitter 614 for each of the HMD 104, the first handheld controller 106(1), and the second handheld controller 106(2). For instance, the case 102 may include a first wireless power transmitter 614 disposed directly underneath or beside a portion of the first recessed area 108(1) and configured to wirelessly transmit power to a first wireless power receiver 720 of the HMD 104, a second wireless power transmitter 614 disposed directly underneath or beside a portion of the second recessed area 108(2) and configured to wirelessly transmit power to a second wireless power receiver 720 of the first handheld controller 106(1), and a third wireless power transmitter 614 disposed directly underneath or beside a portion of the third recessed area 108(3) and configured to wirelessly transmit power to a third wireless power receiver 720 of the second handheld controller 106(2). In this manner, when any one of the HMD 104, the first handheld controller 106(1), or the second handheld controller 106(2) is placed in its designated recessed area 108, the wireless power transmitter 614 that is dedicated to that particular electronic device 700 is aligned with, and in close proximity to, a wireless power receiver 720 of the device 700. In the example of FIG. 2, the case 202 may include a wireless power transmitter 614 disposed directly underneath or beside a portion of the recessed area 208 and configured to wirelessly transmit power to a wireless power receiver 720 of the handheld controller 206. In this manner, when the handheld controller 206 is placed in its designated recessed area 208, the wireless power transmitter 614 of the case 202 is aligned with, and in close proximity to, a wireless power receiver 720 of the handheld controller 206.

The wireless charging described herein may be implemented in various ways, such as via radio charging, inductive charging (or near field charging), magnetic resonance charging, and/or electric field coupling. In an illustrative example, inductive charging is utilized for the wireless charging described herein. In this inductive charging example, the wireless power transmitter(s) 614 of the case 602 may be, or include, an induction coil(s) 616, and the wireless power receiver 720 of an electronic device 700 to be charged (e.g., the HMD 104, the first handheld controller 106(1), the second handheld controller 106(2), the handheld controller 206, etc.) may be, or include, another induction coil(s) 722. The battery 724 of the electronic device 700 may be charged, or recharged, in response to magnetic flux generated by the induction coil(s) 616 of the case 602. For example, an induction coil(s) 616 may be disposed directly underneath the first recessed area 108(1) of the case 102 such that, upon the HMD 104 being placed in the first recessed area 108(1), the HMD 104 will have moved within a threshold distance of the induction coil(s) 616 of the case 102, and the induction coil(s) 722 of the HMD 104 may thereafter receive power wirelessly to charge, or recharge, the battery 724 of the HMD 104. The batteries 724 of the controllers 106 and/or the battery 724 of the controller 206 may be charged, or recharged, in a similar way. In the example of FIG. 1, the batteries 724 of the controllers 106 may be charged, or recharged, either from the same induction coil 616 of the case 102 that is also configured to recharge the battery 724 of the HMD 104, or from separate induction coils 616 of the case 102 that are designated for each of the controllers 106(1) and 106(2). In some examples, when the electronic device 700 is placed in its designated recessed area 108/208, the induction coil 722 of the electronic device 700 may be positioned inside of the induction coil 616 of the case 602. In this example, the induction coil 722 and the induction coil 616 may be substantially concentric and/or coplanar when the electronic device 700 is placed in its designated recessed area 108/208 inside of the case 602, and, in this scenario, the outer coil (induction coil 616) of the case 602 surrounds the inner coil (induction coil 722) of the electronic device 700.

It is to be appreciated that the wireless charging range/distance may vary by implementation. In one example, the wireless charging range/distance may be controlled such that the electronic device 700 (e.g., the HMD 104, the first handheld controller 106(1), the second handheld controller 106(2), the handheld controller 206, etc.) does not start receiving power to recharge the battery 724 until the electronic device 700 is placed in the designated recessed area 108/208 inside of the case 602. In another example, the threshold distance for wireless charging may be greater, and, as such, the electronic device 700 may begin receiving power as soon as the device 700 is within a threshold distance of the induction coil(s) 616 of the case 602, such as within inches of the induction coil(s) 616 of the case 602. Therefore, in some examples, the user may set the electronic device 700 (e.g., the HMD 104, the first handheld controller 106(1), the second handheld controller 106(2), the handheld controller 206, etc.) close to its designated recessed area 108/208 of the case 602, and the electronic device 700 may still be within range to charge, or recharge, the battery 724, even if the device 700 is not seated in the recessed area 108/208. Said another way, the wireless power transmitter(s) 614 of the case 602 may be configured to charge the battery(ies) 724 of an electronic device(s) 700 even when the electronic device(s) 700 is not perfectly seated in the recessed area(s) 108/208 designated for the electronic device(s) 700. Accordingly, in some examples, the user does not have to make sure that the electronic device 700 is seated perfectly in its designated recessed area 108/208 inside of the case 602 to ensure that the battery(ies) 724 of the electronic device(s) 700 is charging. Instead, power may be transferred wirelessly from the case 602 to the electronic device(s) 700 even if the electronic device(s) 700 is askew, misaligned, or otherwise imperfectly seated within its designated recessed area 108/208 inside of the case 602. This can be enabled by controlling the wireless charging range/distance such that the electronic device(s) 700 may begin receiving power as soon as the electronic device(s) 700 is within a threshold distance of the wireless power transmitter(s) 614 (e.g., induction coil(s) 616) of the case 602, such as within inches of wireless power transmitter(s) 614, and even if the wireless power transmitter(s) 614 of the case 602 and the wireless power receiver(s) 720 of the electronic device(s) 700 are not aligned perfectly parallel to one another. In some examples, a processor(s) 608 of the case 602 may dynamically select a coil configuration among multiple different coil configurations to charge the battery(ies) 724 of the electronic device 700 based at least in part on a position of the electronic device 700 relative to the case 602 and/or relative to the recessed area 108/208 that is designated for the electronic device 700. In this manner, charging can be optimized regardless of where the electronic device(s) 700 is/are positioned relative to the case 602. In these examples, relatively slow charging rates may be permissible due to imperfect alignments, and/or greater distances, between the wireless power transmitter(s) 614 and the wireless power receiver(s) 720. This provides for an enhanced user experience where the user can set the electronic device(s) 700 inside of the case 602 (without having to fidget with the position and/or orientation of the electronic device(s) 700 within the case 602), and the electronic device 700 will start charging from power transmitted wirelessly from the case 602.

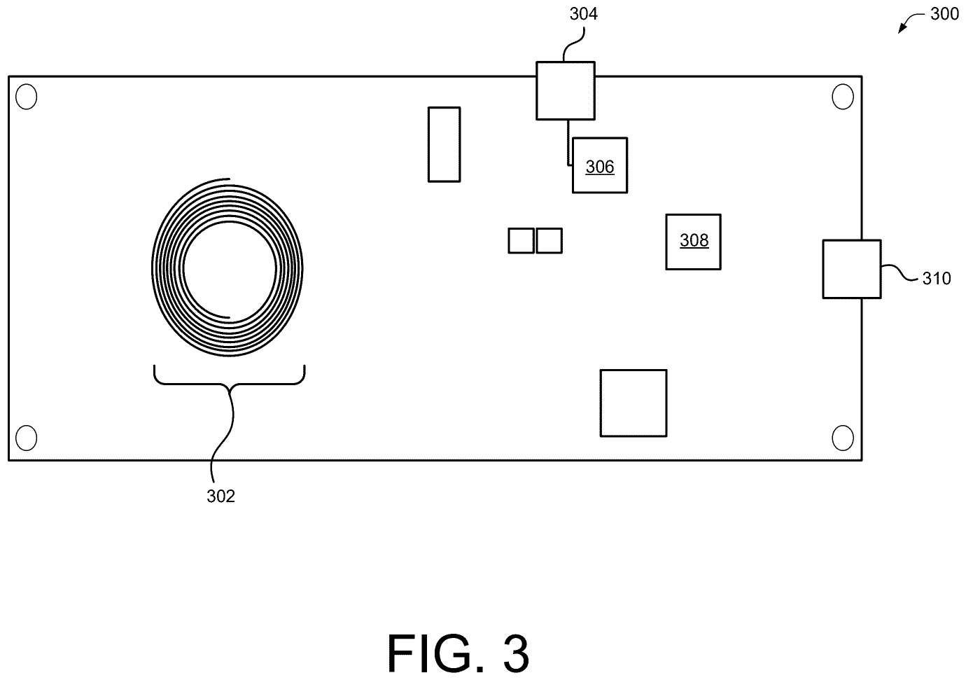

FIG. 3 illustrates an example circuit board 300 that may be housed within the case 602. The example circuit board 300 of FIG. 3 includes an induction coil 302 integrated into the circuit board 300 (sometimes referred to herein as a “circuit board induction coil 302”). The circuit board induction coil 302 depicted in FIG. 3 may represent an example implementation of an induction coil 616 of the case 602, which, in turn, is an example type of wireless power transmitter(s) 614 that is usable with the techniques and systems described herein. The circuit board induction coil 302 may be configured to transmit power wirelessly to an induction coil(s) 722 of an electronic device(s) 700, in accordance with embodiments disclosed herein. For example, AC may pass through the circuit board induction coil 302 to create a magnetic field, which fluctuates in strength because of the AC. This changing magnetic field causes AC to pass through the induction coil(s) 722 of the electronic device(s) 700, which, in turn, may pass through a rectifier to convert the AC to direct current (DC), which can be used to charge the battery(ies) 724 of the electronic device(s) 700.

In some examples, the circuit board induction coil 302 may be in the form of a wire or a trace on the circuit board 300 that winds around itself in a spiral such that the induction coil 302 includes multiple, circular turns of the wire or multiple, circular turns of the trace that lie in the plane of the circuit board 300. The circuit board induction coil 302 depicted in FIG. 3 is an example of a low-cost wireless power transmitter(s) 614 of the case 602. For example, the circuit board induction coil 302 may be made of a copper winding (e.g., 2 ounce (oz) copper) integrated (e.g., built) into the circuit board 300, which is much cheaper to manufacture than a discrete, relatively heavy gauge, copper winding, such as those used for high power applications and/or fast charging (e.g., discrete induction coils rated for wattages of 10 Watts (W) and greater). Because a relatively low charging rate may be permissible for charging the electronic devices 700 described herein, the cost savings to manufacture the case 602 with a low-cost circuit board induction coil 302 as a wireless power transmitter(s) 614 translates to manufacturing efficiencies and a lower retail price for the case 602 and/or a product bundle that includes the case 602. In some examples, the circuit board induction coil 302 has a wire gauge of no less than about 20 American Wire Gauge (AWG). In some examples, the circuit board induction coil 302 may be limited to transmitting a certain amount of power, such as no greater than about 10 W.

As shown in FIG. 3, the circuit board 300 may include a power cable port 310, which may be the same as, or similar to, the power cable ports 110, 210 described above. For example, when the circuit board 300 is integrated into a case 602, the power cable port 310 may be exposed via an external surface of the case 602 so that it can be readily accessed by a user. This is illustrated in the example of FIG. 1 with the power cable port 110 being exposed via an external surface of the case 102, and in the example of FIG. 2 with the power cable port 210 being exposed via an external surface of the case 202. In an example, a user may plug a power cable 112 into the power cable port 310 of the circuit board 300 so that a power source (e.g., mains electricity (or grid power), a PC, a laptop, a battery power bank, etc.) can supply power to the circuit board 300 for powering the circuit board induction coil 302, as well as the other electronic components of the circuit board 300. In some examples, the circuit board 300 may exclude a power cable port 310, such as when there are multiple circuit boards 300 housed within the case 602 and the circuit boards 300 are coupled together, and where one of those circuit boards 300 includes the power cable port 310 to access the power source (e.g., mains electricity (or grid power), a PC, a laptop, a battery power bank, etc.) via a power cable 112, while the other circuit board(s) 300 is/are coupled to the circuit board 300 with the power cable port 310 in order to receive the power from the power source.

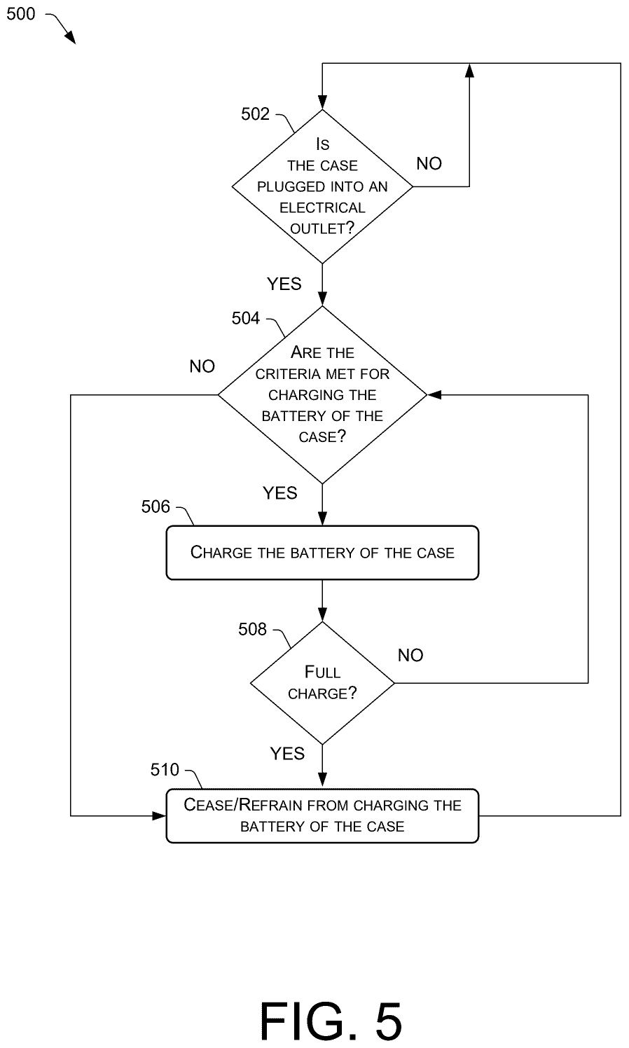

In some examples, the circuit board 300 includes a battery interface 304 that interfaces with the battery connector 630 of the case 602. In this manner, the circuit board 300 is able to access power from a battery(ies) 620 of the case 602 as a secondary (or backup) power source, or as a primary power source when another power source (e.g., mains electricity, a PC, a laptop, a battery power bank, etc.) is unavailable. The battery(ies) 620 depicted in FIG. 6 may be the same as, or similar to, the battery(ies) 120 or the battery(ies) 220 described above. Accordingly, any reference that is made herein to a battery(ies) 620 may be interpreted as a battery(ies) 120 or a battery(ies) 220, in some examples. As shown in FIG. 3, the battery interface 304 can be coupled to a charging circuit 306 that is configured to charge the battery(ies) 620 disposed in the battery receptacle 618 of the case 602. For example, when one end of a power cable 112 is plugged into the power cable port 310, and the other end of the power cable 112 is plugged into an electrical outlet 114, the charging circuit 306 may utilize power received from mains electricity (or grid power) to charge the battery(ies) 620 disposed in the battery receptacle 618 of the case 602. In this manner, the battery(ies) 620 can be recharged, as needed, to maintain enough charge for mobile charging. Example algorithms for charging the batter(ies) 620 of the case 602 are discussed in more detail below, such as with respect to the process 500 of FIG. 5.

In some examples, the circuit board 300 further includes a processor(s) 308. The processor(s) 308 may be configured to cause performance of the techniques, functionality, and/or operations described herein. In some examples, the processor(s) 308 can be implemented as a microcontroller, as a controller and driver integrated circuit (IC), or the like. In some examples, the processor(s) 308 includes circuitry to detect an electronic device 700 (e.g., the HMD 104, the first handheld controller 106(1), the second handheld controller 106(2), the handheld controller 206, etc.) as the device 700 moves within a threshold distance of circuit board 300 and/or the induction coil 302. In some examples, this detection can be based at least in part on the impact that the electronic device 700 has on the induction coil 302 when the electronic device 700 is near (e.g., within a threshold distance of) the induction coil 302. For example, the detection of the electronic device 700 can be based on a change in the perceived inductance of the induction coil 302, such as a change in inductance that satisfies a threshold change. In some examples, the detection of the electronic device 700 can be based on signaling over a particular protocol, such as the Qi protocol, or another custom protocol. In some examples, this circuitry can be, or include, analog ping circuitry, and it can be used by the processor(s) 308 to detect whether the electronic device 700 has been placed in its designated recessed area 108/208 inside of the case 602. Additionally, or alternatively, one or more proximity sensors (e.g., capacitive sensors, infrared (IR) sensors, etc.) can be used by the processor(s) 308 to detect whether an electronic device 700 has been placed in its designated recessed area 108/208 inside of the case 602. Until an electronic device 700 is detected, the processor(s) 308 can place the electronic components of the case 602 into a low power consumption state or mode so that power resources accessible to the case 602 are conserved.

In some examples, the processor(s) 308 is configured to communicate with an electronic device 700 (e.g., the HMD 104, the first handheld controller 106(1), the second handheld controller 106(2), the handheld controller 206, etc.) upon detecting the device 700. This communication can involve transmitting and/or receiving data to and/or from the device 700 to authenticate the electronic device 700. An authenticated device 700 is a device 700 that includes a compliant wireless power receiver 720. Additionally, or alternatively, the communication with the device 700 may be utilized for monitoring fault conditions, such as overheating of the device 700, for detecting interference from metal objects, and the like.

In some examples, the processor(s) 308 is configured to limit and/or adjust an amount of power that is wirelessly transmitted to a wireless power receiver(s) 720 of an electronic device(s) 700 that has been placed in its designated recessed area 108/208 inside of the case 602. Said another way, the processor(s) 308 may be configured to limit and/or adjust the output power of the wireless power transmitter 614 (e.g., the induction coil(s) 616, such as the circuit board induction coil 302) of the case 602. The limiting and/or adjusting of the output power may be based on various criteria and/or factors. For example, the processor(s) 308 may decrease the output power or otherwise limit the output power (e.g., by capping the output power to no greater than a threshold amount of output power) if the available power supply is limited. This may be the case if a reliable, external power source (e.g., mains electricity, a PC, a laptop, a battery power bank, etc.) is unavailable and the charge level of the battery(ies) 620 of the case 602 is below a threshold charge level, or if an external power source is a low voltage power source. As another example, the processor(s) 308 may decrease the output power or otherwise limit the output power once an electronic device(s) 700 in the case 602 is recharged to a threshold charge level. Said another way, when an electronic device(s) 700 is initially placed in the case 602 and the battery(ies) 724 of the device(s) 700 is low on charge or out of charge, the output power may be initially maximized to charge the battery(ies) 724 as fast as possible until a threshold charge level is reached, and from that point on, the processor(s) 308 can decrease the output power or otherwise limit the output power to continue charging the battery(ies) 724 at a slower rate than the initial charging rate. In examples where USB-C charging is utilized, USB Power Delivery (PD) can allow a processor(s) 702 of the electronic device(s) 700 to negotiate power delivery parameters with the processor(s) 308, such as an amount of voltage, maximum current draw, and/or other power delivery parameters. In these examples, a processor(s) 702 of the electronic device(s) 700 may communicate its power requirements to the processor(s) 308, and the processor(s) 308 may adjust an amount of power that is wirelessly transmitted to the wireless power receiver(s) 720 of an electronic device(s) 700 based on the communicated power requirements. In some examples, any transmitted power that is in excess of the amount of power needed to charge the battery(ies) 724 of the device(s) 700 can be redirected and utilized by the device(s) 700 for something else, such as to power one or more electronic components of the device(s) 700 (e.g., indicator lights, wireless radios, etc.). In some examples, the processor(s) 702 and the processor(s) 308 may independently negotiate PD, and renegotiate PD. This negotiation and renegotiation may be accomplished by utilizing a current monitor to monitor the available power (e.g., the amount of electrical current) from the power source, and by dynamically adjusting the output power based on the available power (e.g., as determined via the current monitor). That is, the wireless charging power can be dynamically controlled to remain within an envelope of the available power being supplied from the power source (e.g., a USB-C PD charger).

The processes described herein are illustrated as a collection of blocks in a logical flow graph, which represent a sequence of operations that can be implemented in hardware, software, firmware, or a combination thereof (i.e., logic). In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

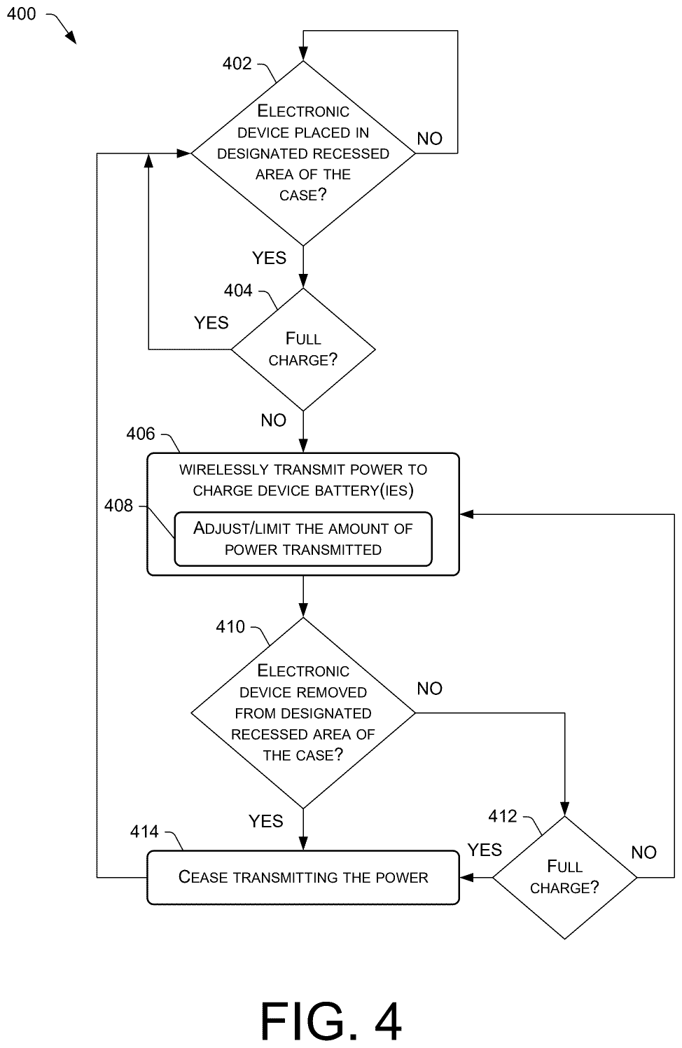

FIG. 4 illustrates a flow diagram of an example process 400 for charging a battery(ies) 724 of an electronic device(s) 700 via wireless power transmission from a case 602 for the electronic device(s) 700, in accordance with embodiments disclosed herein. For discussion purposes, the process 400 is described with reference to the previous figures and the following figures.

At 402, a determination is made as to whether an electronic device 700 has been placed in a recessed area 108/208 inside of the case 602. In some examples, logic (e.g., hardware, software, and/or firmware) of the case 602 may make the determination at block 402. In some examples, a processor(s) 608 of the case 602 (e.g., the processor(s) 308 shown in FIG. 3) may determine whether an electronic device 700 has been placed in a recessed area 108/208 inside of the case 602 based on the impact that the electronic device 700 has on the induction coil(s) 616 of the case 602 (e.g., based on a change in the perceived inductance of the induction coil(s) 616), and/or based on signaling over a particular protocol, such as the Qi protocol, or another custom protocol. In some examples, the electronic device 700 is a HMD 104. In some examples, the electronic device 700 is a handheld controller 106, 206. In some examples, the recessed area 108/208 is shaped to receive the electronic device 700, as described above. In some examples, the shape of the recessed area 108/208 can serve as an alignment aid such that, when the electronic device 700 is placed in the recessed area 108/208, the electronic device 700 is seated in the recessed area 108/208, thereby orienting the electronic device 700 such that the wireless power transmitter(s) 614 of the case 602 is aligned with, and in close proximity to, a wireless power receiver 720 of the electronic device 700, and the detection of the electronic device 700 at block 402 may be based at least in part on achieving this alignment and/or close proximity. In some examples, the recessed area 108/208 may include one or more first magnets, and an attractive force between the first magnet(s) and one or more second magnets disposed on the electronic device 700 can facilitate seating the electronic device 700 within the recessed area 108/208 to aid in the detection at block 402 and/or to aid in more efficient wireless charging. In some examples, the electronic device 700 includes one or more datums that provide feedback to the user for optimally positioning and/or orienting the electronic device 700 within the recessed area 108/208 to optimize detection of the device 700 and/or to optimize wireless charging performance. For example, one or more markers and/or other features disposed on the electronic device 700 may be configured to align with, or to be positioned a predefined distance from, corresponding markers and/or other features disposed on the case 602 when the electronic device 700 is optimally seated within its designated recessed area 108/208. By ensuring that these markers and/or features are aligned or otherwise positioned properly relative to each other, detection of the device 700 and/or wireless charging performance can be optimized. If an electronic device 700 is not detected at block 402, the process 400 may follow the NO route from block 402 to iterate the determination at block 402. For example, the logic of the case 602 may continually monitor for the presence of an electronic device 700 in a recessed area 108/208 inside of the case 602 in a passive manner (e.g., by waiting for a change in inductance of the induction coil(s) 616), and/or the logic may periodically (e.g., every few seconds) use signaling (e.g., Qi protocol signaling) to check for the presence of an electronic device 700 in the case 602. If the logic of the case 602 detects that an electronic device 700 has been placed in a recessed area 108/208 inside of the case 602 at block 402, the process 400 may follow the YES route from block 402 to block 404.

At 404, a determination is made as to whether a battery 724 of the electronic device 700 has full charge, or at least an above-threshold amount of charge, such that charging the battery 724 is not warranted. In some examples, the logic of the case 602 may make the determination at block 402. For example, the processor(s) 608 of the case 602 (e.g., the processor(s) 308 shown in FIG. 3) may request, from the electronic device 700, a charge level of the battery 724 of the electronic device 700, and the electronic device 700 may respond to the request by determining the current charge level of the battery 724 and sending corresponding data to the processor(s) 608, which may be received (e.g., wirelessly) via a communications interface(s) 626 of the case 602. In some examples, signaling via a particular protocol, such as the Qi protocol, may be utilized at block 404 to determine the charge level of the battery 724. If it is determined that the battery 724 of the electronic device 700 has full charge, or at least an above-threshold amount of charge, the process 400 may follow the YES route from block 404 to iterate the determination at block 402. In this example, the electronic device 700 may remain seated in the recessed area 108/208 of the case 602, and if the electronic device 700 remains powered on, the charge level of the battery 724 may decrease over time such that the determination at block 404 may eventually be a determination that the battery 724 does not have full charge, or does not have an above-threshold amount of charge. In this event, the process 400 may follow the NO route from block 404 to block 406.

At 406, in response to determining that the electronic device 700 has been placed in a recessed area 108/208 inside of the case 602 at block 402, and in response to determining that the battery 724 of the electronic device 700 does not have full charge (or an above-threshold amount of charge) at block 404, a wireless power transmitter(s) 614 of the case 602 may wirelessly transmit power received from a power source to a wireless power receiver 720 of the electronic device 700 to charge the battery(ies) 724 of the electronic device 700. In some examples, the logic of the case 602 may cause the wireless power transmitter(s) 614 to transmit the power wirelessly at block 406. For example, the processor(s) 608 of the case 602 (e.g., the processor(s) 308 shown in FIG. 3) may cause the wireless power transmitter(s) 614 of the case 602 to wirelessly transmit the power at block 406. In some examples, the wireless power transmitter(s) 614 is an induction coil(s) 616, such as the circuit board induction coil 302 shown in FIG. 3), and the wireless power receiver 720 of the electronic device 700 is another induction coil(s) 722. In these examples, the induction coil(s) 722 of the electronic device 700 may charge, or recharge, the battery 724 at block 406 in response to magnetic flux generated by the induction coil(s) 616 (e.g., the circuit board induction coil 302) of the case 602. In some examples, the induction coil 302 of the case 602 is integrated into a circuit board 300 of the case 602 as a low-cost wireless charging solution. In some examples, the power source that provides the power for wireless charging at block 406 is mains electricity, a PC, a laptop, a battery power bank, or the like. In some examples, the power source is a battery(ies) 620 of the case 602.

At sub-block 408, in some examples, an amount of the power that is wirelessly transmitted to the wireless power receiver 720 at block 406 may be adjusted (e.g., decreased or increased) and/or limited to a maximum amount of power. In some examples, the logic of the case 602 may adjust and/or limit the amount of power transmitted at sub-block 408. For example, the processor(s) 608 of the case 602 (e.g., the processor(s) 308 shown in FIG. 3) may adjust and/or limit the amount of the power transmitted at sub-block 408 based on various criteria and/or factors, such as the power source supplying a limited amount of power (e.g., a charge level of the battery(ies) 620 being below a threshold charge level, a voltage of power source being below a threshold voltage, etc.), a charge level of the battery(ies) 724 of the device 700, or the like. Any adjustment of the output power at sub-block 408 may cause a change in the charging rate of the battery(ies) 724 (e.g., by causing the battery(ies) 724 to charge slower or faster).

At 410, a determination is made as to whether the electronic device 700 has been removed from the recessed area 108/208 inside of the case 602. In some examples, the logic of the case 602 may make the determination at block 410. In some examples, a processor(s) 608 of the case 602 (e.g., the processor(s) 308 shown in FIG. 3) may determine whether the electronic device 700 has been removed from the recessed area 108/208 inside of the case 602 based on a change in the perceived inductance of the induction coil(s) 616, and/or based on signaling over a particular protocol, such as the Qi protocol, or another custom protocol. If an electronic device 700 is still detected as being disposed in the recessed area 108/208 at block 410, the process 400 may follow the NO route from block 410 to block 412.

At 412, a determination is made as to whether the battery 724 of the electronic device 700 has reached a full charge, or at least an above-threshold amount of charge, such that charging the battery 724 can be ceased to conserve power resources. In some examples, the logic of the case 602 may make the determination at block 412. For example, the processor(s) 608 of the case 602 (e.g., the processor(s) 308 shown in FIG. 3) may request, from the electronic device 700, a charge level of the battery 724 of the electronic device 700, and the electronic device 700 may respond to the request by determining the current charge level of the battery 724 and sending corresponding data to the processor(s) 608, which may be received (e.g., wirelessly) via a communications interface(s) 626 of the case 602. In some examples, signaling via a particular protocol, such as the Qi protocol, may be utilized at block 412 to determine the charge level of the battery 724. If it is determined that the battery 724 of the electronic device 700 has not reached full charge, or at least an above-threshold amount of charge, the process 400 may follow the NO route from block 412 to block 406 where the wireless power transmitter(s) 614 may continue transmitting the power wirelessly to the wireless power receiver 720 of the electronic device 700. As wireless charging continues, the charge level of the battery 724 may increase over time such that the determination at block 412 may eventually be a determination that the battery 724 has reached full charge, or at least an above-threshold amount of charge. In this event, the process 400 may follow the YES route from block 412 to block 414. Alternatively, if it is determined, at block 410, that the electronic device 700 has been removed from the recessed area 108/208 inside of the case 602, the process 400 may follow the YES route from block 410 to block 414.

At 414, in response to detecting that the electronic device 700 has been removed from the recessed area 108/208 inside of the case 602 at block 410, or in response to determining that the battery 724 of the electronic device 700 has reached full charge (or an above-threshold amount of charge) at block 412, the wireless power transmitter(s) 614 of the case 602 may cease transmitting the power to the wireless power receiver 720 of the electronic device 700. In some examples, the logic of the case 602 may cause the wireless power transmitter(s) 614 to cease transmitting the power at block 414. For example, the processor(s) 608 of the case 602 (e.g., the processor(s) 308 shown in FIG. 3) may cause the wireless power transmitter(s) 614 of the case 602 to cease transmitting the power at block 414. Following block 414, the process 400 may iterate from block 402 to continually charge and cease charging one or more batteries 724 of one or more electronic devices 700 as the device(s) 700 is/are placed in, and removed from, the recessed area(s) 108/208 of the case 602. In the example of the case 102 depicted in FIG. 1, for instance, the process 400 may iterate for each of the HMD 104, the first handheld controller 106(1), and/or the second handheld controller 106(2) as these devices 700 are placed in their designated recessed areas 108 and removed therefrom. Accordingly, the process 400 may be performed once for the HMD 104, and again for the first handheld controller 106(1), and yet again for the second handheld controller 106(2). In this example, multiple different electronic devices 700 can be charged wirelessly via the same case 102 by implementing the process 400 with respect to each of the devices 700. In some examples, a single electronic device 700 can be repeatedly placed in, and removed from, the case 602, in which case the process 400 may iterate with respect to the placement of the device 700 in, and removal of the device 700 from, the case 602.

FIG. 5 illustrates a flow diagram of an example process 500 for charging a battery(ies) 620 of a case 602 for an electronic device(s) 700, in accordance with embodiments disclosed herein. For discussion purposes, the process 500 is described with reference to the previous figures and the following figures.

At 502, a determination is made as to whether the case 602 is plugged into an electrical outlet 114. In some examples, logic (e.g., hardware, software, and/or firmware) of the case 602 may make the determination at block 502. In some examples, a processor(s) 608 of the case 602 (e.g., the processor(s) 308 shown in FIG. 3) may make the determination at block 502 based at least in part on whether a power cable 112 is plugged into a power cable port 610 of the case 602 and/or whether a change in voltage is detected via the power cable port 610. Since the power cable port 610 shown in FIG. 6 may be the same as, or similar to, any of the power cable ports 110, 210, and/or 310 described above, any reference that is made herein to a power cable port 610 may be interpreted as a power cable port 110, 210, or 310. If it is determined, at block 502, that the case 602 is not plugged into an electrical outlet 114, the process 500 may follow the NO route from block 502 to iterate the determination at block 502. For example, the logic of the case 602 may continually monitor for the presence of a power cable 112 in the power cable port 610 in a passive manner (e.g., by waiting for a change in voltage at the power cable port 610), and/or the logic may periodically (e.g., every few seconds) check for the presence of a power cable 112 in the power cable port 610. If the logic of the case 602 determines that the case 602 is plugged into an electrical outlet 114 at block 502, the process 500 may follow the YES route from block 502 to block 504.

At 504, a determination is made as to whether one or more criteria are met for charging a battery(ies) 620 of the case 602. In some examples, the logic of the case 602 may make the determination at block 504. In some examples, a processor(s) 608 of the case 602 (e.g., the processor(s) 308 shown in FIG. 3) may evaluate the criteria at block 504. Example criteria that can be evaluated at block 504 include, without limitation, whether the battery(ies) 620 has less than a full charge, or less than a threshold amount of charge, whether an electronic device(s) 700 has been removed from its designated recessed area(s) 108/208 inside of the case 602, whether the battery(ies) 724 of the electronic device(s) 700 disposed in the recessed area(s) 108/208 inside of the case 602 has a charge level that satisfies (e.g., meets or exceeds, or strictly exceeds) a threshold charge level, or the like. For instance, it may not be resourceful to charge the battery(ies) 620 of the case 602 if the battery(ies) 620 already has enough charge (e.g., full charge, an above-threshold amount of charge, etc.), and/or if there is an electronic device(s) 700 disposed in the case 602 that is in need of charging (e.g., because the current charge level of the battery(ies) 724 is below a threshold charge level and/or less than full charge). On the other hand, power from mains electricity may be used to charge the battery(ies) 620 of the case 602 at opportune times, such as when there are no electronic devices 700 in the case 602 (e.g., when the case 602 is empty), and/or when any electronic devices 700 disposed in the case 602 have an above-threshold amount of charge and, therefore, do not need to be charged. If the criteria are met at block 504, the process 500 may follow the YES route from block 504 to block 506.

At 506, based on determining that the case 602 is plugged into an electrical outlet 114 at block 502, and in response to determining that the criteria are met at block 504, the battery(ies) 620 of the case 602 may be charged, or recharged using power from mains electricity (or grid power). In some examples, the logic of the case 602 may cause a charging circuit 306 of the case 602 to charge the battery(ies) 620 of the case 602 at block 506. For example, the processor(s) 608 of the case 602 (e.g., the processor(s) 308 shown in FIG. 3) may cause the charging circuit 306 to direct power received via the power cable port 610 to the battery connector(s) 630 of the case 602 via the battery interface 304 to cause the battery(ies) 620 of the case 602 to charge, or recharge, at block 506.

At 508, a determination is made as to whether the battery(ies) 620 of the case 602 has reached a full charge, or at least an above-threshold amount of charge, such that charging the battery(ies) 620 can be ceased to conserve power resources. In some examples, the logic of the case 602 may make the determination at block 508. For example, the processor(s) 608 of the case 602 (e.g., the processor(s) 308 shown in FIG. 3) may determine a current charge level of the battery(ies) 620 via the battery interface 304. If it is determined that the battery(ies) 620 has not reached full charge, or at least an above-threshold amount of charge, the process 500 may follow the NO route from block 508 to block 504 to evaluate the criteria again at block 504. For example, if the user places an electronic device 700 with low charge in the case 602 while the battery(ies) 620 is charging, such an event may result in the criteria no longer being met at block 504 after following the NO route from block 508. Assuming, however, that the criteria is still met at block 504, the process 500 may iterate blocks 504 to 508 to continue charging the battery(ies) 620 of the case 602 over a period of time. As this charging continues, the charge level of the battery(ies) 620 may increase over time such that the determination at block 508 may eventually be a determination that battery(ies) 620 has reached full charge, or at least an above-threshold amount of charge. In this event, the process 500 may follow the YES route from block 508 to block 510. Alternatively, if it is determined, at block 504, that the criteria are not met, the process 500 may follow the NO route from block 504 to block 510.

At 510, the logic of the case 602 may cease, or refrain from, charging the battery(ies) 620 of the case 602. For example, if the process 500 follows the NO route from block 504 to block 510, the logic of the case 602 may refrain from charging the battery(ies) 620, and the process 500 may return to block 502 to iterate the process 500. For example, if, on a subsequent iteration of the process 500, the criteria are met at block 504, the battery(ies) 620 of the case 602 may be charged, or recharged, at least temporarily. In another example, if the process 500 follows the YES route from block 508 to block 510, the logic of the case 602 may cease charging the battery(ies) 620. For example, the processor(s) 608 of the case 602 (e.g., the processor(s) 308 shown in FIG. 3) may cause the charging circuit 306 of the case 602 to cease charging the battery(ies) 620 of the case 602 at block 510. In this example, the process 500 can iterate by returning to block 502.

FIG. 6 illustrates example components of a case 602 for an electronic device(s) 700, in accordance with embodiments disclosed herein. The case 602 may be the same as, or similar to, the case 102 or the case 202 described above. The case 602 may be configured to store one or more electronic devices 700 of a particular type. For example, the case 602 may be configured to store a HMD 104, a first handheld controller 106(1), and/or a second handheld controller 106(2). An example of a case 102 that is configured to store the HMD 104, the first handheld controller 106(1), and the second handheld controller 106(2) is described above with reference to FIG. 1. In another examples, the case 602 may be configured to store a handheld controller 206. An example of a case 202 that is configured to store the handheld controller 206 is described above with reference to FIG. 2. Accordingly, an electronic device(s) 700 can be stored in, and/or stowed in, the case 602, such as when the device(s) 700 is/are not being used, and/or when a user would like to transport the device(s) 700 from one geographic location to another geographic location. In other words, the case 602 can function as a carrying case, in some examples. It is to be appreciated, however, that the case 602 can be utilized as a “docking station” of sorts. The case 602 may be used in this way by users who do not travel with their electronic device(s) 700, and/or by users when they are not traveling with their electronic device(s) 700.

In the illustrated implementation, the case 602 includes a processor(s) 608 and memory 604 (e.g., computer-readable media 604). The processor(s) 608 may be the same as, or similar to, the processor(s) 308 described above. In some implementations, the processors(s) 608 may include a central processing unit (CPU) (s), a graphics processing unit (GPU) (s), both CPU(s) and GPU(s), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), etc. Additionally, each of the processor(s) 608 may possess its own local memory, which also may store program modules, program data, and/or one or more operating systems.

The memory 604 may include volatile and nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable read-only memory (EEPROM), flash memory or other memory technology, compact disk ROM (CD-ROM), digital versatile disk (DVD) or other optical storage, magnetic cassettes, magnetic tape, magnetic disk storage or other magnetic storage devices, redundant array of independent disks (RAID) storage systems, or any other medium which can be used to store the desired information and which can be accessed by a computing device. The memory 604 may be implemented as computer-readable storage media (CRSM), which may be any available physical media accessible by the processor(s) 608 to execute instructions stored on the memory 604. In one basic implementation, CRSM may include RAM and Flash memory. In other implementations, CRSM may include, but is not limited to, ROM, EEPROM, or any other non-transitory and/or tangible medium which can be used to store the desired information and which can be accessed by the processor(s) 608.

In general, the case 602 may include logic (e.g., software, hardware, and/or firmware, etc.) that is configured to implement the techniques, functionality, and/or operations described herein. The memory 604 can include various modules, such as instruction, datastores, and so forth, which may be configured to execute on the processor(s) 608 for carrying out the techniques, functionality, and/or operations described herein. An example functional module in the form of a charging component 612 is shown as being stored in the memory 604. The charging component 612 may represent computer-executable instructions that are executable by the processor(s) 608 to perform the techniques, functionality, and/or operations described herein. For example, the processor(s) 608 may execute the charging component 612 to perform the process 400 and/or the process 500 described above. It is to be appreciated, however, that the same, or similar, functionality may alternatively be implemented in hardware, firmware, or as a SOC, and/or other logic. Furthermore, additional or different functional modules may be stored in the memory 604 and executable on the processor(s) 608.

The case 602 may further include one or more wireless power transmitters 614. The wireless power transmitter(s) 614 is configured to wirelessly transmit power received from a power source (e.g., mains electricity, a battery(ies) 620 of the case 602, etc.) to a wireless power receiver(s) 720 of an electronic device(s) 700. In some examples, the wireless power transmitter(s) 614 is configured to wirelessly transmit the power to a wireless power receiver(s) 720 of an electronic device(s) 700 in response to the electronic device(s) 700 being placed in its designated recessed area 108/208 inside of the case 602. This wireless transmission of the power allows for charging a battery(ies) 724 of the electronic device(s) 700. For example, in response to an electronic device 700 being placed in a recessed area 108/208 inside of the case 602, a wireless power transmitter 614 of the case 602 may wirelessly transmit power to a wireless power receiver 720 of the electronic device 700 to automatically charge, or recharge, a battery(ies) 724 of the electronic device 700. In some examples, a single wireless power transmitter 614 of the case 602 may be configured to wirelessly transmit power to multiple wireless power receivers 720 of multiple electronic devices 700, such as the HMD 104, the first handheld controller 106(1), and the second handheld controller 106(2) depicted in FIG. 1. In some examples, the case 602 includes a wireless power transmitter 614 dedicated for a specific electronic device 700. For example, the case 602 may have multiple (e.g., three) wireless power transmitters 614, each wireless power transmitter 614 being dedicated for a particular electronic device 700 of multiple electronic devices 700 that are configured to be stored in the case 602. In some examples, the wireless power transmitter 614 is disposed directly underneath a portion of the recessed area 108/208 in which the electronic device 700 is to be placed, and the transmitter 614 is configured to wirelessly transmit power to a wireless power receiver 720 of that electronic device 700. In this manner, when any one of multiple electronic devices 700 is placed in its designated recessed area 108/208, the wireless power transmitter 614 that is dedicated to that particular device 700 is aligned with, and in close proximity to, a wireless power receiver 720 of the device 700.

As mentioned above, the wireless charging described herein may be implemented in various ways, such as via radio charging, inductive charging (or near field charging), magnetic resonance charging, and/or electric field coupling. In an illustrative example, inductive charging is utilized for the wireless charging described herein. In this inductive charging example, the wireless power transmitter(s) 614 of the case 602 may be, or include, an induction coil(s) 616, such as a winding of copper wire. In this example, an induction coil(s) 616 may be disposed directly underneath or beside a recessed area 108/208 inside of the case 602 such that, upon placement of an electronic device 700 in the recessed area 108/208, the electronic device 700 will have moved within a threshold distance of the induction coil(s) 616 of the case 602, and another induction coil(s) 722 of the electronic device 700 may thereafter receive power wirelessly to charge, or recharge, the battery 724 of the electronic device 700. In some examples, the batteries 724 of multiple different electronic devices 700 may be charged, or recharged, from the same induction coil(s) 616 of the case 602, or from separate induction coils 616 of the case 602. In the latter example, each induction coil 616 of the case 602 can be dedicated for a particular electronic device 700 and/or a particular recessed area 108/208 inside of the case 602.

It is to be appreciated that the wireless charging range/distance may vary by implementation. In one example, the wireless charging range/distance may be controlled such that the electronic device 700 does not start receiving power to recharge the battery 724 until the electronic device 700 is placed in the designated recessed area 108/208 inside of the case 602. In another example, the threshold distance for wireless charging may be greater, and, as such, the electronic device 700 may begin receiving power as soon as the device 700 is within a threshold distance of the induction coil(s) 616 of the case 602, such as within inches of the induction coil(s) 616 of the case 602. Therefore, in some examples, a user may set the electronic device 700 close to its designated recessed area 108/208, and the electronic device 700 may still be within range to charge, or recharge, the battery 724, even if the device 700 is not seated in the recessed area 108/208. Said another way, the wireless power transmitter(s) 614 of the case 602 may be configured to charge the battery(ies) 724 of an electronic device(s) 700 even when the electronic device(s) 700 is not perfectly seated in the recessed area(s) 108/208 designated for the electronic device(s) 700. Accordingly, in some examples, the user does not have to make sure that the electronic device 700 is seated perfectly in its designated recessed area 108/208 inside of the case 602 to ensure that the battery(ies) 724 of the electronic device(s) 700 is charging. Instead, power may be transferred wirelessly from the case 602 to the electronic device(s) 700 even if the electronic device(s) 700 is askew, misaligned, or otherwise imperfectly seated within its designated recessed area 108/208 inside of the case 602. This can be enabled by controlling the wireless charging range/distance such that the electronic device(s) 700 may begin receiving power as soon as the electronic device(s) 700 is within a threshold distance of the wireless power transmitter(s) 614 (e.g., induction coil(s) 616) of the case 602, such as within inches of wireless power transmitter(s) 614, and even if the wireless power transmitter(s) 614 of the case 602 and the wireless power receiver(s) 720 of the electronic device(s) 700 are not aligned perfectly parallel to one another. In these examples, relatively slow charging rates may be permissible due to imperfect alignments, and/or greater distances, between the wireless power transmitter(s) 614 and the wireless power receiver(s) 720. This provides for an enhanced user experience where the user can set the electronic device(s) 700 inside of the case 602 (without having to fidget with the position and/or orientation of the electronic device(s) 700 within the case 602), and the electronic device 700 will start charging from power transmitted wirelessly from the case 602

In some examples, the induction coil(s) 616 of the case 602 may be the same as, or similar to, the circuit board induction coil 302 described above with reference to FIG. 3. That is, the induction coil 616, in some examples, may be in the form of a wire or a trace on a circuit board 300 of the case 602, the wire or the trace winding around itself in a spiral such that the induction coil 616 includes multiple, circular turns of the wire or multiple, circular turns of the trace in the plane of the circuit board 300. Such an induction coil 302 is an example of a low-cost wireless power transmitter 614 of the case 602.

In some examples, the case 602 may further include input devices 622 and output devices 624. The input devices 622 may include control buttons. In some implementations, one or more microphones may function as input devices 622 to receive audio input, such as user voice input. In some implementations, one or more cameras or other types of sensors (e.g., inertial measurement unit (IMU)) may function as input devices 622 to receive gestural input, such as a hand motion of the user, to capture face images for facial recognition, etc. In some embodiments, additional input devices 622 may be provided in the form of a keyboard, keypad, mouse, touch screen, joystick, and the like. In other embodiments, the case 602 may omit a keyboard, keypad, or other similar forms of mechanical input. Instead, the case 602 may be implemented relatively simplistic forms of input device 622, a communications interface 626 (wireless or wire-based), power, and processing/memory capabilities. For example, a limited set of one or more input devices 622 may be employed (e.g., a dedicated button to initiate a configuration, power the case 602 on/off, etc.) so that the case 602 can thereafter be used. In one implementation, the input device(s) 622 may include control mechanisms, such as power and/or reset buttons.

The output devices 624 may include, without limitation, a light element(s) (e.g., light emitting diode(s) (LED(s))), a vibrator to create haptic sensations, a speaker(s) (e.g., headphones), a display(s), and/or the like. There may also be a simple light element (e.g., LED) to indicate a state such as, for example, when power is on, when an electronic device(s) 700 is/are being charged, when the battery(ies) 620 is being charged, is low on charge, or the like. In some examples, colored light elements (e.g., LEDs) can be used to indicate a charge level of any of the batteries described herein. For example, a LED positioned adjacent to the first recessed area 108(1) of the example case 102 of FIG. 1 may output a red color when the HMD 104 is placed in the first recessed area 108(1) and when the battery(ies) 724 of the HMD 104 is low on charge (e.g., below a first threshold charge level). This LED can change to a yellow or amber color when the charge level of the battery(ies) 724 of the HMD 104 transitions above the first threshold charge level, and/or the LED can change to a green color when the charge level of the battery(ies) 724 of the HMD 104 transitions above a second threshold charge level that is greater than the first threshold charge level, which may indicate that the HMD 104 has been fully charged, or has reached the second threshold charge level, in some examples. Similar colored lights can be implemented for indicating the charge level/status of any of the electronic devices 700 described herein.

In some examples, the case 602 may further include a communications interface(s) 626, such as a wireless unit coupled to an antenna(s) to facilitate a wireless connection to a network. Such a wireless unit may implement one or more of various wireless technologies, such as Wi-Fi, Bluetooth, RF, and so on. It is to be appreciated that the case 602 may further include physical ports to facilitate a wired connection to a network, a connected peripheral device, or a plug-in network device that communicates with other wireless networks.

In some examples, the case 602 further includes one or more connectors 628 configured to access one or more power sources. For example, the case 602 may include a first connector in the form of a power cable port 610, which may be the same as, or similar to, the power cable ports 110, 210, and/or 310 described above. The power cable port 610 may be configured to receive a power cable 112 to access mains electricity (or grid power) as a power source. As another example, the case 602 may additionally, or alternatively, include a battery receptacle 618, which may be the same as, or similar to, the battery receptacle 118 and/or 218 described above. In this examples, a second connector in the form of a battery connector 630 (e.g., terminal(s), contact(s), etc.) may be disposed within the battery receptacle 618. When a battery(ies) 620 is disposed within the battery receptacle 618, the battery(ies) 620 is connected to the battery connector 630 to allow for accessing power from the battery(ies) 620 as a power source. The battery(ies) 620 may be the same as, or similar to, the battery(ies) 120 and/or 220 described above.

In some examples, the case 602 further includes a charging circuit 606, which may be the same as, or similar to, the charging circuit 306 described above. The charging circuit 606 may be configured to charge the battery(ies) 620 disposed in the battery receptacle 618 of the case 602. For example, when one end of a power cable 112 is plugged into the power cable port 610 and the other end of the power cable 112 is plugged into an electrical outlet 114, the charging circuit 606 may utilize power received from mains electricity (or grid power) to charge the battery(ies) 620 disposed in the battery receptacle 618 of the case 602. In this manner, the battery(ies) 620 can be recharged, as needed, to maintain enough charge for mobile charging.

FIG. 7 illustrates example components of an electronic device(s) 700 that is configured to be stored in, transported by, and/or charged wirelessly by, a case 602, in accordance with embodiments disclosed herein. The electronic device 700 can represent the HMD 104, the first handheld controller 106(1), the second handheld controller 106(2), and/or the handheld controller 206, each of which is described above. It is to be appreciated, however, that the electronic device 700 can represent other types of devices, such as a laptop computer, a mobile phone, a tablet computer, another wearable computer (e.g., a smart watch, etc.), or any other electronic device that includes a rechargeable battery(ies).

In the illustrated implementation, the electronic device(s) 700 includes the one or more processors 702 and the memory 704 (e.g., computer-readable media 704). In some implementations, the processors(s) 702 may include a CPU(s), a GPU(s), both a CPU(s) and a GPU(s), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include FPGAs, ASICs, ASSPs, SOCs, CPLDs, etc. Additionally, each of the processor(s) 702 may possess its own local memory, which also may store program modules, program data, and/or one or more operating systems.

The memory 704 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, DVD or other optical storage, magnetic cassettes, magnetic tape, magnetic disk storage or other magnetic storage devices, RAID storage systems, or any other medium which can be used to store the desired information and which can be accessed by a computing device. The memory 704 may be implemented as CRSM, which may be any available physical media accessible by the processor(s) 702 to execute instructions stored on the memory 704. In one basic implementation, CRSM may include RAM and Flash memory. In other implementations, CRSM may include, but is not limited to, ROM, EEPROM, or any other non-transitory and/or tangible medium which can be used to store the desired information and which can be accessed by the processor(s) 702.

In general, the electronic device(s) 700 may include logic (e.g., software, hardware, and/or firmware, etc.) that is configured to implement the techniques, functionality, and/or operations described herein. The memory 704 is shown as including various modules, such as instruction, datastores, and so forth, which may be configured to execute on the processor(s) 702 for carrying out the techniques, functionality, and/or operations described herein. A few example functional modules are shown as stored in the memory 704 and executable on the processor(s) 702, although the same functionality may alternatively be implemented in hardware, firmware, or as a SOC, and/or other logic.

An operating system module 706 may be configured to manage hardware within and coupled to the electronic device(s) 700 for the benefit of other modules. In addition, in some instances the electronic device(s) 700 may include one or more applications 708 stored in the memory 704 or otherwise accessible to the electronic device(s) 700. In some examples, the application(s) 708 includes a gaming application (e.g., a video game, such as a video game, a VR video game, etc.). However, the electronic device(s) 700 may include any number or type of applications and is not limited to the specific example shown here. A charging component(s) 710 may represent computer-executable instructions that are executable by the processor(s) 702 to perform the techniques, functionality, and/or operations described herein.

Generally, the electronic device(s) 700 has input devices 712 and output devices 714. The input devices 712 may include one or more microphones to receive audio input, such as user voice input. In some implementations, one or more cameras or other types of sensors, such as an inertial measurement unit (IMU), or the like, may function as input devices 712. For example, an IMU may be configured to detect head motion of a user wearing the electronic device(s) 700 (e.g., the HMD 104), hand motion of the user holding the electronic device(s) 700 (e.g., the handheld controller(s) 106, 206), including for gestural input purposes. In some embodiments, additional input devices 712 may be provided in the form of a keyboard, keypad, mouse, touch screen, joystick, D-pads, buttons, trackpads, and the like.

The output devices 714 may include a display(s), which can utilize any suitable type of display technology, such as an emissive display that utilizes light emitting elements (e.g., LEDs) to emit light during presentation of frames on the display(s). As an example, a display(s) of the electronic device(s) 700 may comprise liquid crystal displays (LCDs), organic light emitting diode (OLED) displays, inorganic light emitting diode (ILED) displays, or any other suitable type of display technology. The output devices 714 may further include, without limitation, a light element (e.g., LED), a vibrator to create haptic sensations, as well as one or more speakers.

The electronic device(s) 700 may further include sensors 716, such as sensors 716 to generate motion, position, and orientation data, such as gyroscopes, accelerometers, magnetometers, color sensors, or other motion, position, and orientation sensors. The sensors 716 may also include sub-portions of sensors, such as a series of active or passive markers that may be viewed externally by a camera or color sensor in order to generate motion, position, and orientation data. The sensors 716 may include light sensors that are sensitive to light (e.g., IR or visible light) that is projected or broadcast by base stations in the environment of the electronic device(s) 700. The sensor(s) 716 may include an IMU(s) that generates calibration data based on measurement signals received from accelerometers, gyroscopes, magnetometers, and/or other sensors suitable for detecting motion, correcting error associated with IMU, or some combination thereof. Based on the measurement signals such motion-based sensors, such as the IMU, may generate calibration data indicating an estimated position of electronic device(s) 700 relative to an initial position of the electronic device(s) 700. For example, multiple accelerometers may measure translational motion (forward/back, up/down, left/right) and multiple gyroscopes may measure rotational motion (e.g., pitch, yaw, and roll). An IMU can, for example, rapidly sample the measurement signals and calculate the estimated position of the electronic device(s) 700 from the sampled data. For example, IMU may integrate measurement signals received from the accelerometers over time to estimate a velocity vector and integrates the velocity vector over time to determine an estimated position of a reference point on electronic device(s) 700. The reference point is a point that may be used to describe the position of the electronic device(s) 700. While the reference point may generally be defined as a point in space, in various embodiments, reference point is defined as a point within electronic device(s) 700 (e.g., a center of the IMU). Alternatively, an IMU provides the sampled measurement signals to an external console (or other computing device), which determines the calibration data.

The sensors 716 may operate at relatively high frequencies in order to provide sensor data at a high rate. For example, sensor data may be generated at a rate of 1000 Hz (or 1 sensor reading every 1 millisecond). In this way, one thousand readings are taken per second. When sensors generate this much data at this rate (or at a greater rate), the data set used for predicting motion is quite large, even over relatively short time periods on the order of the tens of milliseconds. As mentioned, in some embodiments, the sensors 716 may include light sensors that are sensitive to light emitted by base stations in the environment of the electronic device(s) 700 for purposes of tracking position and/or orientation, pose, etc., of the electronic device(s) 700 in 3D space. The calculation of position and/or orientation may be based on timing characteristics of light pulses and the presence or absence of light detected by the sensors 716.

The electronic device(s) 700 may further include a communications interface(s) 718, such as a wireless unit coupled to an antenna(s) to facilitate a wireless connection to a network. Such a wireless unit may implement one or more of various wireless technologies, such as Wi-Fi, Bluetooth, RF, and so on. It is to be appreciated that the electronic device(s) 700 may further include physical ports to facilitate a wired connection to a network, a connected peripheral device (including a personal computer (PC), a game console, etc.), or a plug-in network device that communicates with other wireless networks.

The electronic device(s) 700 may further include one or more wireless power receivers 720. In some examples, the wireless power receiver(s) 720 is configured to wirelessly receive power from a wireless power transmitter(s) 614 of the case 602 in response to the electronic device 700 being placed in its designated recessed area 108/208 of the case 602. This wireless reception of the power allows for charging a battery(ies) 724 of the electronic device 700. For example, in response to the electronic device(s) 700 being placed in a recessed area 108/208 inside of the case 602, a wireless power receiver(s) 720 of the electronic device(s) 700 may wirelessly receive power from a wireless power transmitter(s) 614 of the case 602 to automatically charge, or recharge, a battery 724 of the electronic device(s) 700.

As mentioned above, the wireless charging described herein may be implemented in various ways, such as via radio charging, inductive charging (or near field charging), magnetic resonance charging, and/or electric field coupling. In an illustrative example, inductive charging is utilized for the wireless charging described herein. In this inductive charging example, the wireless power receiver(s) 720 of the electronic device(s) 700 may be, or include, an induction coil(s) 722, such as a winding of copper wire. In some examples, the induction coil(s) 722 of the electronic device(s) 700 has a wire gauge that is thinner than the wire gauge of the induction coil(s) 616 of the case 602 (e.g., the induction coil(s) 722 may have an AWG value that is greater than the AWG value of the induction coil(s) 616). In some examples, the induction coil(s) 722 of the electronic device(s) 700 has more turns of wire than the turns of wire of the induction coil(s) 616 of the case 602 (e.g., the induction coil(s) 722 may a greater number of circular turns of wire than the number of circular turns of wire of the induction coil(s) 616). These relationships between wire gauge and/or the number of turns may optimize wireless charging performance. The battery 724 of the electronic device(s) 700 may be charged, or recharged, in response to magnetic flux generated by another induction coil(s) 616 of the case 602. For example, an induction coil(s) 616 may be disposed directly underneath the a recessed area 108/208 of the case 602 such that, upon the electronic device(s) 700 being placed in the recessed area 108/208, the electronic device(s) 700 will have moved within a threshold distance of the induction coil(s) 616 of the case 602, and the induction coil(s) 722 of the electronic device(s) 700 may thereafter receive power wirelessly to charge, or recharge, the battery 724 of the electronic device(s) 700. It is to be appreciated that the wireless charging range/distance may vary by implementation. In one example, the wireless charging range/distance may be controlled such that the electronic device 700 does not start receiving power to recharge the battery 724 until the electronic device 700 is placed in the designated recessed area 108/208 inside of the case 602. In another example, the threshold distance for wireless charging may be greater, and, as such, the electronic device 700 may begin receiving power as soon as the device 700 is within a threshold distance of the induction coil(s) 616 of the case 602, such as within inches of the induction coil(s) 616 of the case 602. Therefore, in some examples, the user may set the electronic device 700 close to its designated recessed area 108/208, and the electronic device 700 may still be within range to charge, or recharge, the battery 724, even if the device 700 is not seated, or is imperfectly seated, in the recessed area 108/208, as described in detail above. In some examples, the electronic device(s) 700 may be powered by the battery(s) 724. Additionally, or alternatively, the electronic device(s) 700 may include a power cable port to connect to an external power source via wired means, such as a power cable 112.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
a head-mounted display (HMD) comprising a first battery and a first wireless power receiver;
a first handheld controller comprising a second battery and a second wireless power receiver;
a second handheld controller comprising a third battery and a third wireless power receiver; and
a case configured to store and transport the HMD, the first handheld controller, and the second handheld controller, wherein the case comprises:
a first recessed area inside of the case, the first recessed area being shaped to receive the HMD;
a second recessed area inside of the case, the second recessed area being shaped to receive the first handheld controller;
a third recessed area inside of the case, the third recessed area being shaped to receive the second handheld controller;
a connector configured to access a power source; and
one or more wireless power transmitters configured to wirelessly transmit power received from the power source to:
the first wireless power receiver in response to the HMD being placed in the first recessed area to automatically recharge the first battery;
the second wireless power receiver in response to the first handheld controller being placed in the second recessed area to automatically recharge the second battery; and
the third wireless power receiver in response to the second handheld controller being placed in the third recessed area to automatically recharge the third battery.

2. The system of claim 1, wherein the one or more wireless power transmitters comprise one or more induction coils integrated into one or more circuit boards of the case.

3. The system of claim 1, wherein the case further comprises a processor configured to adjust or limit an amount of the power that is wirelessly transmitted to the first wireless power receiver, the second wireless power receiver, and the third wireless power receiver.

4. The system of claim 1, wherein the connector comprises a battery connector disposed within a battery receptacle of the case, wherein the power source is a fourth battery disposed within the battery receptacle and connected to the battery connector, and wherein the case further comprises:
a power cable port disposed on an external surface of the case and configured to receive a power cable;
a charging circuit configured to charge the fourth battery using additional power received from an additional power source via the power cable; and
a processor configured to cause the charging circuit to charge the fourth battery using the additional power in response to determining that:
the HMD has been removed from the first recessed area;
the first handheld controller has been removed from the second recessed area; and
the second handheld controller has been removed from the third recessed area.

5. The system of claim 1, wherein the connector comprises a battery connector disposed within a battery receptacle of the case, wherein the power source is a fourth battery disposed within the battery receptacle and connected to the battery connector, and wherein the case further comprises:
a power cable port disposed on an external surface of the case and configured to receive a power cable;
a charging circuit configured to charge the fourth battery using additional power received from an additional power source via the power cable; and
a processor configured to cause the charging circuit to charge the fourth battery using the additional power in response to determining that:
the first battery has a first charge level that satisfies a threshold charge level;
the second battery has a second charge level that satisfies the threshold charge level; and
the third battery has a third charge level that satisfies the threshold charge level.

6. A case for an electronic device, the case comprising:
a recessed area inside of the case, the recessed area being shaped to receive the electronic device, wherein the electronic device is at least one of a head-mounted display (HMD) or a handheld controller;
a connector configured to access a power source; and
a wireless power transmitter configured to wirelessly transmit power received from the power source to a wireless power receiver of the electronic device in response to the electronic device being placed in the recessed area to charge a battery of the electronic device.

7. The case of claim 6, wherein the wireless power transmitter comprises an induction coil integrated into a circuit board of the case.

8. The case of claim 6, further comprising a processor configured to adjust or limit an amount of the power that is wirelessly transmitted to the wireless power receiver.

9. The case of claim 8, wherein the processor is configured to adjust or limit the amount of the power based at least in part on the power source supplying a limited amount of power, or on a charge level of the battery.

10. The case of claim 6, wherein the connector comprises a power cable port disposed on an external surface of the case and configured to receive a power cable.

11. The case of claim 6, wherein the connector comprises a battery connector disposed within a battery receptacle of the case, and wherein the power source is a second battery disposed within the battery receptacle and connected to the battery connector.

12. The case of claim 11, further comprising:
a power cable port disposed on an external surface of the case and configured to receive a power cable; and
a charging circuit configured to charge the second battery using additional power received via the power cable.

13. The case of claim 11, wherein the battery receptacle is configured to receive different types of batteries, and wherein the second battery is one of the different types of batteries.

14. The case of claim 6, wherein the recessed area is a first recessed area, wherein the electronic device is the HMD, and wherein the handheld controller is a first handheld controller, the case further comprising:
a second recessed area inside of the case, the second recessed area being shaped to receive the first handheld controller; and
a third recessed area inside of the case, the third recessed area being shaped to receive a second handheld controller,
wherein the wireless power transmitter is, or one or more additional wireless power transmitters of the case are, configured to wirelessly transmit the power to:
a second wireless power receiver of the first handheld controller in response to the first handheld controller being placed in the second recessed area to charge a second battery of the first handheld controller; and
a third wireless power receiver of the second handheld controller in response to the second handheld controller being placed in the third recessed area to charge a third battery of the second handheld controller.

15. A method comprising:
determining, by a processor of a case for an electronic device, that the electronic device has been placed in a recessed area inside of the case, wherein the recessed area is shaped to receive the electronic device, and wherein the electronic device is at least one of a head-mounted display (HMD) or a handheld controller; and
in response to the determining, causing, by the processor, a wireless power transmitter of the case to wirelessly transmit power received from a power source to a wireless power receiver of the electronic device to charge a battery of the electronic device.

16. The method of claim 15, further comprising adjusting, by the processor, an amount of the power that is wirelessly transmitted to the wireless power receiver based at least in part on the power source supplying a limited amount of power, or on a charge level of the battery.

17. The method of claim 15, further comprising:
determining, by the processor, that the electronic device has been removed from the recessed area; and
in response to the determining that the electronic device has been removed from the recessed area, causing, by the processor, the wireless power transmitter to cease transmitting the power to the wireless power receiver.

18. The method of claim 17, further comprising:
determining, by the processor, that the case is plugged into an electrical outlet via a power cable connected to a power cable port of the case; and
based at least in part on the determining that the case is plugged into the electrical outlet, and in response to the determining that the electronic device has been removed from the recessed area, causing, by the processor, a charging circuit of the case to charge a second battery disposed within a battery receptacle of the case using additional power received via the power cable.

19. The method of claim 15, further comprising:
determining, by the processor, that the case is plugged into an electrical outlet via a power cable connected to a power cable port of the case;
determining, by the processor, that the battery has a charge level that satisfies a threshold charge level; and
based at least in part on the determining that the case is plugged into the electrical outlet, and in response to the determining that the battery has the charge level that satisfies the threshold charge level, causing, by the processor, a charging circuit of the case to charge a second battery disposed within a battery receptacle of the case using additional power received via the power cable.

20. The method of claim 15, wherein the recessed area is a first recessed area, wherein the electronic device is the HMD, wherein the handheld controller is a first handheld controller, and wherein the case is for the HMD, the first handheld controller, and a second handheld controller, the method further comprising:
determining, by the processor, that the first handheld controller has been placed in a second recessed area inside of the case, wherein the second recessed area is shaped to receive the first handheld controller;
in response to the determining that the first handheld controller has been placed in the second recessed area, causing, by the processor, the wireless power transmitter, or a second wireless power transmitter of the case, to wirelessly transmit the power to a second wireless power receiver of the first handheld controller to charge a second battery of the first handheld controller;
determining, by the processor, that the second handheld controller has been placed in a third recessed area inside of the case, wherein the third recessed area is shaped to receive the second handheld controller; and
in response to the determining that the second handheld controller has been placed in the third recessed area, causing, by the processor, the wireless power transmitter, or a third wireless power transmitter of the case, to wirelessly transmit the power to a third wireless power receiver of the second handheld controller to charge a third battery of the second handheld controller.
